(19) United States
(12) Patent Application Publication
(10) Pub. No.: US 2015/0270624 A1
(43) Pub. Date: Sep. 24, 2015

(54) RF WAVE BENDER

(71) Applicant: SRD Innovations Inc., Calgary (CA)

(72) Inventors: Michel Fattouche, Calgary (CA); Sayed-Amr El-Hamamsy, Calgary (CA); Dikran Tchairdjian, Calgary (CA)

(73) Assignee: SRD Innovations Inc., Calgary (CA)

(21) Appl. No.: 14/223,817

(22) Filed: Mar. 24, 2014

(51) Int. Cl. H01Q 19/185; G01S 3/14; H01Q 15/14

(52) U.S. Cl. CPC H01Q 19/185; H01Q 15/14; G01S 3/14

(57) ABSTRACT

The present invention relates generally to the field of wireless communication and, in particular, to the field of reducing shadowing and multipath fading over a wireless link. According to a broad aspect of this invention, there is provided a novel design of a passive reflector repeater and a set of methods to be used to configure a set of reflector repeaters to bend RF waves around obstacles along the direct path of a wireless link.

### FIELD OF THE INVENTION

The present invention relates generally to the field of wireless communications where it is desirable to communicate between wireless devices, at the highest possible communication rate, while reducing the complexity, cost of deployment and power consumption of each device, and reducing the complexity, cost of deployment and power consumption of the network infrastructure (base station, backhaul etc.), without significantly increasing the communication latency between devices.

The present invention relates to wireless devices which communicate over a varied number of physical communications channel such as satellite, radio, and microwave.

The present invention relates to a varied number of applications such as point to point communications, point to multipoint communications, multipoint to point communications, and multipoint to multipoint communications.

### BACKGROUND OF THE INVENTION

In many applications, it is desirable to communicate between wireless devices in an efficient way where power consumption and cost of each device are reduced while the transmission rate between devices is increased. In most applications, cost reduction is obtained by reducing the complexity of the device. Moreover, reducing the power consumption of each device while increasing the transmission rate between devices can be usually considered as a trade-off between power efficiency and bandwidth efficiency. This trade-off takes place on one of the most hostile communication channels, the wireless channel, where one must contend with shadowing, radio interference, multipath fading as well as thermal noise. Shadowing is caused by obstacles along the direct path between a transmitting antenna, A_{T}, and a receiving antenna, A_{R}, which force the received signal to be weak and the thermal noise to dominate, hence creating a noise-limited environment. On the other hand, interference from other intentional radiators creates an environment where the received signal is limited by the so-called background noise and the environment is said to be interference-limited. Multipath fading is caused by objects surrounding the direct path between A_{T} and A_{R}, which act as radio reflectors reflecting the transmitted signal from A_{T} back to the receiving antenna, A_{R}, using multiple paths, each path having a corresponding carrier amplitude, phase and time delay. When the receiving antenna, A_{R}, receives signals from the various paths in a multipath environment, the signals can be received either out-of-phase (also known as destructive multipath interference) or in-phase (also known as constructive multipath interference) depending on the frequency of operation.

A common way to overcome shadowing in a wireless channel is by using a number of active (regenerative) repeaters between A_{T} and A_{R}. Active repeaters have several shortcomings. They require by definition a power source. They are relatively complex, as they must contain a full transceiver capable of regenerating the received information, and unless some type of Frequency Division Duplex (FDD) protocol is adopted and the RF receiver in each active repeater is well isolated from its RF transmitter, every active repeater between A_{T} and A_{R} can either transmit or receive at a time, but not transmit and receive simultaneously. In other words, unless some type of FDD protocol is adopted, the bit rate between transmitting antenna, A_{T}, and receiving antenna, A_{R}, is linearly reduced by the number of active repeaters between them and the latency between them is directly increased by the same factor. Lastly, an active repeater can only exacerbate the Hidden Terminal Problem (HTP), a problem which occurs when active nodes cannot hear each other (or equivalently cannot sense each other), thereby potentially colliding with each other when transmitting simultaneously in the Carrier Sense Multiple Access with Collision Avoidance (CSMA/CA) environment.

There are two types of passive repeaters: (1) reflector repeaters and (2) back-to-back antenna repeaters. Reflector repeaters reflect the wireless signals in the same way a mirror reflects light. The same laws apply. Back-to-back antenna repeaters work just like an ordinary active repeater, but without radio frequency transposition or amplification of the signal. In other words, back-to-back antenna repeaters are neither active nor regenerative. Reflector repeaters are more attractive than back-to-back antenna repeaters due to the fact that their efficiency is close to 100% as opposed to efficiency between 50% and 60% for back-to-back antenna repeaters. Reflector repeaters are also more flexible in terms of size, shape and cost than back-to-back antenna repeaters, which are usually limited by the type of directional high gain antenna selected, e.g., parabolic or yagi.

### SUMMARY OF THE INVENTION

In an embodiment, there is disclosed an easy to deploy RF reflector repeater, which is referred to as a wave bender. It can be used as a way to mitigate shadowing and to reduce multipath fading and the Hidden Terminal Problem over the wireless channel. The wave bender can accomplish this by supplementing the direct path between a transmitting antenna, A_{T}, and a receiving antenna, A_{R}, with an indirect path, which follows free space path loss attenuation.

There are several applications of the wave bender:

The RF wave bender can be used as a reflector repeater between one stationary transmitting antenna, A_{T}, and one stationary receiving antenna, A_{R}. In this case, it is considered to create one deterministic indirect path between the two antennas. We will refer to such a communication application as point-to-point communication. Examples include fixed wireless communications.

The RF wave bender can be used as a reflector repeater between one (or more) fixed (stationary) transmitting antenna(s) and a number of mobile receiving antennas, or vice versa, between a number of mobile transmitting antennas and one (or more) fixed (stationary) receiving antenna(s). Once again, the RF wave bender can be considered to create one deterministic indirect path between each fixed antenna and a corresponding coverage area where the mobile antennas could be located attempting to communicate with the fixed antenna(s). We will refer to such a communication application as point-to-multipoint communication. Examples include Global Positioning Systems (GPS), cellular (such as LTE), Metropolitan Area Networks (also known as Fixed Wireless Access networks such as WiMAX) and WiFi (IEEE802.11) communications, which are centralized via a satellite (GPS), a Base Station (cellular) or an Access Point (WiFi) respectively. The examples are not limited to the listed systems but can be extended to any point-to-multipoint communication system by one familiar with the art.

The RF wave bender can be used as a reflector repeater between a number of fixed transmitting antennas and a number of fixed receiving antennas. In this case, the RF wave bender can be considered to create deterministic indirect paths between several fixed transmitting antennas, and several fixed receiving antennas, or equivalently to create two coverage areas: one where the fixed transmitting antennas could be located and one where the fixed receiving antennas could be located. We will refer to such a communication application as fixed multipoint-to-multipoint communication. Examples include mesh and ad-hoc communications, which are both peer-to-peer (non-centralized), and do not require either a Base Station or an Access Point.

The RF wave bender can be used as a reflector repeater between a number of mobile transmitting antennas and a number of mobile receiving antennas. In this case, the RF wave bender can be considered to create random (probabilistic) indirect paths between several mobile transmitting antennas, and several mobile receiving antennas, or equivalently to create two coverage areas: one where the mobile transmitting antennas could be located and one where the mobile receiving antennas could be located. We will refer to such a communication application as mobile multipoint-to-multipoint communication. Examples include mesh and ad-hoc communications, which are both peer-to-peer (non-centralized), and do not require either a Base Station or an Access Point.

The RF wave bender can also be used in a combined fixed and mobile multipoint to multipoint communication network by applying the two principles listed above of random and deterministic coverage areas simultaneously.

In order for the wave bender to be easily deployed, its elements are preferably lightweight, small in size and easy to configure. On the other hand, in order for the wave bender to require low maintenance, its elements are preferably passive (i.e. no power source), withstand heavy wind loading and be unaffected by severe weather conditions.

### DESCRIPTION OF THE DRAWINGS

The present invention, both as to its organization and manner of operation, may best be understood by reference to the following description, and the accompanying drawings of various embodiments wherein like reference numerals are used throughout the several views, and in which:

FIG. 1a is a 2-dimensional schematic view of a generic embodiment of a wave bender (103) used as a reflector repeater between a transmitting antenna (106), A_{T}, and a receiving antenna (107), A_{R}, where the direct path (108) between A_{T} (106) and A_{R} (107) is shadowed (i.e. impaired) by an obstacle (109). The wave bender (103) bends the incoming wave (101) by a desired angle α₂ (104), relative to the incoming wave (101), to an outgoing wave (105) thereby creating an indirect non-shadowed path (101, 105) between A_{T} (106) and A_{R} (107) to replace the impaired direct path (108).

FIG. 1b is a 3-dimensional schematic view of a generic embodiment of a wave bender (103) used as a reflector repeater between a transmitting antenna (106), A_{T}, and a receiving antenna (107), A_{R}, where the direct path (108) between A_{T} (106) and A_{R} (107) is shadowed (i.e. impaired) by an obstacle (109). The wave bender (103) bends the incoming wave (101) by a desired angle α₂ (104), relative to the incoming wave (101), to an outgoing wave (105) thereby creating an indirect non-shadowed path (101, 105) between A_{T} (106) and A_{R} (107) to replace the impaired direct path (108). In this invention, we refer to the plane that is made up of the incident wave (101) and of the reflected wave (105) as the “wave plane.” It is easily shown that the wave plane contains both the desired angle α₂ (104) and the axis (112) of the reflector. In this invention, the axis of the reflector is perpendicular to the structure of the reflector, regardless whether the reflector is a 2D structure or a 3D structure. Equivalently, in this invention we will say that the wave plane is perpendicular to the reflector, regardless of the structure of the reflector. In FIG. 1b, bending the incoming wave (101) by the desired angle α₂ (104) corresponds to shifting the incoming wave (101) in the horizontal plane by an angle π-φ₂ (111), and in the vertical plane by an angle γ₂ (110).

FIG. 2 is a 2-dimensional schematic view of a generic embodiment of two reflectors (203, 207) used as a wave bender between transmitting antenna (210), A_{T}, and receiving antenna (211), A_{R}, where the direct path (213) between A_{T} (210) and A_{R}(211) is shadowed by several obstacles (212, 214). The two reflectors (203, 207) bend the incoming wave (201) by a desired angle α₃ (209), relative to the incoming wave (201), to an outgoing wave (208) thereby creating an indirect non-shadowed path (201, 205, 208) between A_{T} (210) and A_{R} (211) to replace the impaired direct path (213). In FIG. 2, the wave plane for the first reflector (203) is parallel to the wave plane of the second reflector (207). Generally, this is not always true, and FIG. 2 can be easily generalized to depict a 3-dimensional wave bender, where the wave plane for the first reflector (203) is not necessarily parallel to the wave plane of the second reflector (207).

FIG. 3 is a 2-dimensional schematic view of a generic embodiment of three reflectors (303, 307, 311) used as a wave bender between transmitting antenna (314), A_{T}, and receiving antenna (315), A_{R}, where the direct path (319) between A_{T} (314) and A_{R} (315) is shadowed by several obstacles (317, 318). The three reflectors (303, 307, 311) bend the incoming wave (301) by a desired angle α₄ (313), relative to the incoming wave (301), to an outgoing wave (312) thereby creating an indirect non-shadowed path (301, 305, 308, 312) between A_{T} (314) and A_{R} (315) to replace the impaired direct path (319). Once again, FIG. 3 can be easily generalized to depict a 3-dimensional wave bender, where the wave plane for the first reflector (303) is not necessarily parallel to the wave plane of either the second reflector (307) or the third reflector (311). All 2-dimensional wave benders can be easily generalized to depict 3-dimensional wave benders where the wave planes of the individual reflectors are not necessarily parallel to one another.

FIG. 4 is a 2-dimensional schematic view of a generic embodiment of a reflector (403) used as a wave bender between transmitting antenna (406), A_{T}, and receiving antenna (407), A_{R}, where the direct path between A_{T} (406) and A_{R} (407) is shadowed by an obstacle (408). The wave bender (403) bends the incoming wave (401) to an outgoing wave (405) thereby creating the illusion of a direct path, (410, 405), between the image (409) of the transmitting antenna, A_{T}, (406) and the receiving antenna (407), A_{R}. In FIG. 4, the incident wave (401), the outgoing wave (405) and the imaged wave (110) are all contained in the wave plane that is perpendicular to the reflector (403).

FIG. 5 is a 2-dimensional schematic view of a generic embodiment of two reflectors (503, 507) used as a wave bender between transmitting antenna (510), A_{T}, and receiving antenna (511), A_{R}, where the direct path between A_{T} (510) and A_{R}(511) is shadowed by several obstacles (512, 513). The first reflector (503) reflects the incoming wave (501) to an outgoing wave (505) thereby creating the illusion of a direct path, (506, 505), between the image (504) of the transmitting antenna, A_{T}, (510) and the second reflector (507). The second reflector (507) reflects the first image (504) to an outgoing wave (508) thereby creating the illusion of a direct path, (510, 509, 508), between the image (514) of the first image (504) and the receiving antenna, A_{R}, (511). In FIG. 5, the waves (501), (504) and (505), are all contained in the wave plane that is perpendicular to the first reflector (503). Similarly, the waves (505), (508) and (514) are all contained in the wave plane that is perpendicular to the second reflector (507).

FIG. 6 is a 2-dimensional schematic view of a generic embodiment of three reflectors (602, 607, 611) used as a wave bender between transmitting antenna (614), A_{T}, and receiving antenna (620), A_{R}, where the direct path between A_{T} (614) and A_{R} (620) is shadowed by several obstacles (615, 617). The first reflector (602) reflects the incoming wave (601) to an outgoing wave (605) thereby creating the illusion of a direct path, (604, 605), between the image (603) of the transmitting antenna, A_{T}, (614) and the second reflector (607). The second reflector (607) reflects the incoming wave (605) to an outgoing wave (608) thereby creating the illusion of a direct path, (610, 613, 608), between the image (609) of the first image (603) of the transmitting antenna (614) and the third reflector (611). The third reflector (611) reflects the second image (609) of the transmitting antenna (614) to an outgoing wave (612) thereby creating the illusion of a direct path, (618, 619, 621, 612), between the third image (622) of the second image (609) of the transmitting antenna (614) and the receiving antenna, A_{R}, (620). In FIG. 6, the waves (601), (604) and (605), are all contained in the wave plane that is perpendicular to the first reflector (602). Similarly, the waves (605), (608) and (609) are all contained in the wave plane that is perpendicular to the second reflector (607). Similarly, the waves (608), (612) and (621) are all contained in the wave plane that is perpendicular to the second reflector (611).

FIG. 7a is a 3-dimensional depiction of a preferred embodiment of a reflector, the rectangular reflector, which consists generally of three components: a rectangular framed conducting grid (701), which is attached to a tripod (703) via an articulated arm (702).

FIG. 7b is a 3-dimensional depiction of another preferred embodiment of a reflector, the elliptical reflector, which consists generally of three components: an elliptical framed conducting grid (704), which is attached to a tripod (706) via an articulated arm (705).

FIG. 8a is a zoomed-in 3-dimensional depiction of the preferred embodiment of the rectangular reflector from FIG. 7a. FIG. 8a shows once again the three general components of a rectangular reflector: a rectangular framed conducting grid (801), which is attached to a tripod (803) via an articulated arm (802). The framed conducting grid (801) is made of a conducting material where all crossings form an electrical contact, i.e. the electrical resistance between any two points on the grid is negligible.

FIG. 8b is a zoomed-in 3-dimensional depiction of the preferred embodiment of the elliptical reflector from FIG. 7b. FIG. 8b shows once again the general components of an elliptical reflector: an elliptical frame (805) and a conducting grid (804), both attached to a tripod (809) via an articulated arm. The articulated arm comprises 3 sub-components: the first rubber ball (808) that is attached to a second rubber ball (807) using a lateral holder (806), which is capable to tighten its grip on both balls (808) and (807). The framed conducting grid (804) is made of a conducting material where all crossings form an electrical contact, i.e. the electrical resistance between any two points on the grid is negligible.

FIG. 9 is a break-down of the 3-dimensional depiction of a preferred embodiment of the rectangular reflector including the framed conducting grid (701, 801), which comprises two sub-components: a conducting grid (901) and a frame (902); and the articulated arm (702, 802), which comprises 3 sub-components: the first rubber ball (903) that is attached to the second rubber ball (905) using a lateral holder (904), which is capable to tighten its grip on both balls (903) and (905). The tripod (703, 803) is not shown in FIG. 9.

FIG. 10 is a 2-dimensional schematic view of a preferred embodiment of the conducting grid (801), which is a rectangular conducting grid with a width W₁ (1001) and a height H₁ (1004). The grid (801) is made up of rectangular openings with width w₁ (1003) and height h₁ (1002).

FIG. 11 is a 2-dimensional schematic view of a generic embodiment of a system intended to locate a transmitting antenna (106) using one reflector (103) of known location and one active node (113) of known location. In FIG. 11, it is assumed that the active node (113) comprises an antenna array (112) and a receiver, which together are able to estimate angles β₁ (114) and β₂ (115), corresponding to direct path (108) and indirect path (105) respectively.

FIG. 12 is a 2-dimensional schematic view of a generic embodiment of a system intended to locate a transmitting antenna (106) using one reflector (103) of known location and one active node (117) also of known location. In FIG. 12, it is assumed that the active node (117) comprises one antenna (118) and a receiver, which together are able to estimate the Time of Arrival of any wireless signal transmitted by the transmitting antenna. Given that the transmitted wireless signal in FIG. 12 is able to travel via either the direct path (108) or the indirect path (101, 105), it assumed in this invention that the active node (117) is able to estimate the two received signals with respect to their respective Times of Arrival: τ₁ and τ₂ which correspond to the direct path (108) and the indirect path (101, 105) respectively.

FIG. 13 is a 2-dimensional schematic view of a generic embodiment of a system intended to locate a receiving antenna (121) using one reflector (103) of known location and one active node (119) also of known location. In FIG. 13, it is assumed that the active node (119) comprises one antenna (120) and a transmitter. In FIG. 13, it is also assumed that the receiving antenna is able to, estimate the Time of Arrival of any wireless signal transmitted by the active node. Given that the transmitted wireless signal in FIG. 13 is able to travel via either the direct path (122) or the indirect path (123, 124), it assumed in this invention that the receiving antenna (121) is able to estimate the two received signals with respect to their respective Times of Arrival: τ₁ and τ₂ which correspond to the direct path (122) and the indirect path (123, 124) respectively.

### DETAILED DESCRIPTION OF THE INVENTION

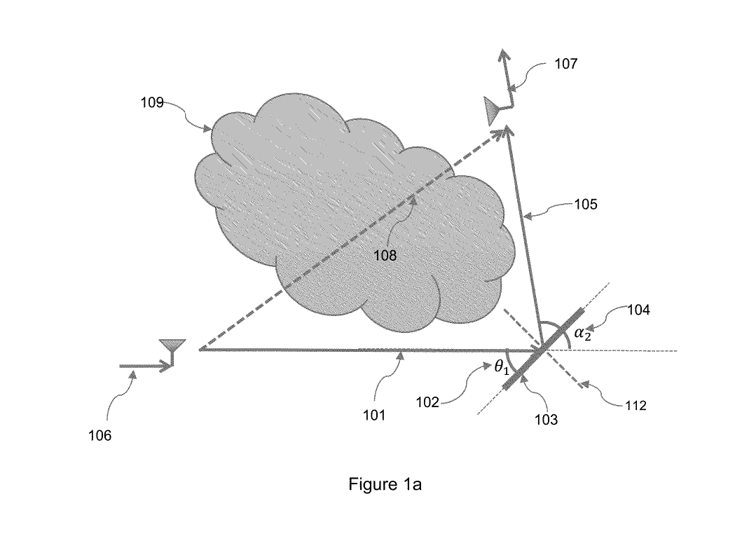

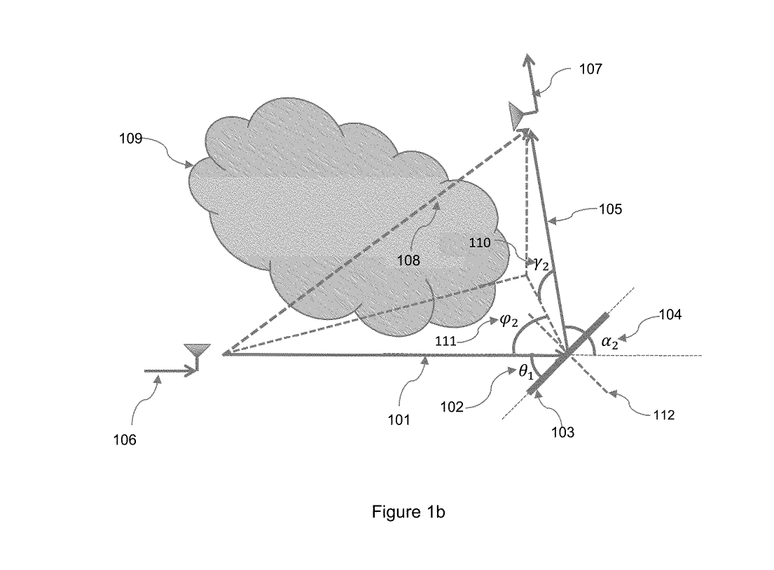

The most convenient way to describe the problem that the current invention attempts to solve is through the figures. In FIG. 1, obstacle (109) is said to form a shadowing effect between transmitting antenna (106), A_{T}, and receiving antenna (107), A_{R}, when the signal traveling along the direct path (108) between A_{T} (106) and A_{R}(107) is attenuated to the point that the Signal Power-to-Noise Power Ratio (SNR) falls below a certain threshold. In this case, the thermal noise is said to dominate the received signal, and the channel is said to be noise-limited. Such a channel can be adequately modeled using the following equation:

$${P}_{r} = {{P}_{t} ( \frac{λ}{4 π d} )}^{n} {G}_{t} {G}_{r} \qquad ( 1 )$$

where
Pₜ is the transmitted power from A_{T};
Pᵣ is the received power at A_{R};
Gₜ is the antenna gain for A_{T};
Gᵣ is the antenna gain for A_{R}:
d is the length of the direct path (108) between A_{T} and A_{R};
Δ is the wavelength of the transmitted wave (101) and of the reflected wave (105); and
n is the path loss exponent which is modeled as 2. i.e. as free space, when the direct path between A_{T} and A_{R} contains no obstructions nor multipath components. However, when the direct path (108) between A_{T} and A_{R} is shadowed by obstacles (109), such as the case in FIG. 1, the path loss exponent, n, generally grows larger than 2 depending on the absorption properties of the obstacles (109) at the operating wavelength λ.

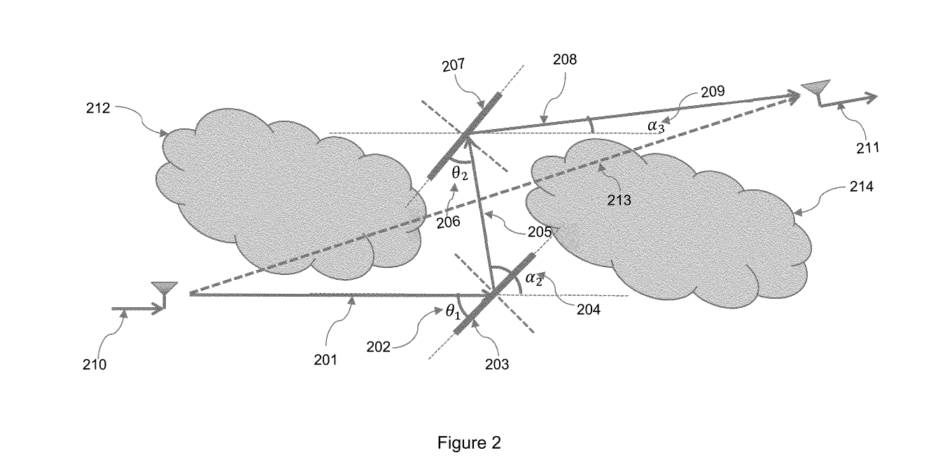

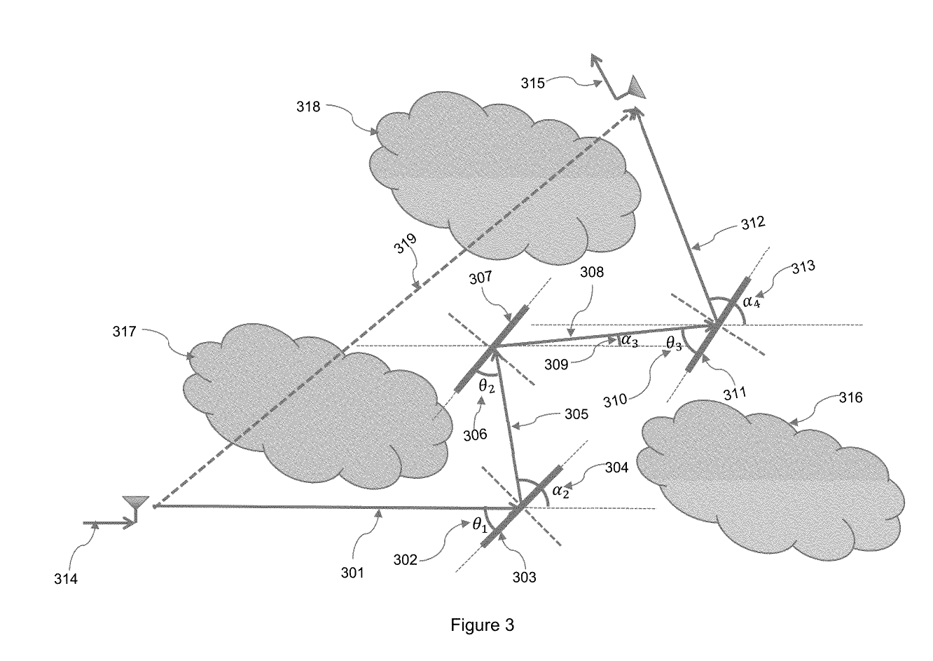

The RF Wave Bender provides a way to circumvent the obstacles (109) through the use of a number of passive reflector repeaters, such as one (103) in FIG. 1, two (203, 207) in FIG. 2, and three (303, 307, 311) in FIG. 3. The collection of passive reflector repeaters (or reflectors for short) is a wave bender.

Traditionally, reflectors have been modeled using the following radar equation:

$$\begin{matrix}{P}_{r} = {{P}_{t} ( \frac{λ}{4 π {d}_{t}} )}^{2} {( \frac{1}{4 π {d}_{r}} )}^{2} {G}_{t} ( \frac{4 π {A}_{r}}{{λ}^{2}} ) \\ = {P}_{t} ( \frac{1}{4 π {d}_{t}^{2}} ) ( \frac{1}{4 π {d}_{r}^{2}} ) {G}_{t} {A}_{r} σ\end{matrix} \qquad ( 2 )$$

where
Pₜ is the transmitted power from A_{T} (106);
Pᵣ is the received power at A_{R} (107);
Gₜ is the antenna gain for A_{T} (106);
A_{T} is the effective antenna aperture for A_{R} (107);
dₜ is the length of the direct path (101) between A_{T} (106) and the reflector (103);
dᵣ is the length of the direct path (105) between the reflector (103) and A_{R} (107):
λ is the wavelength of the transmitted wave (101) and reflected wave (105); and
σ is the radar cross section of the reflector (103).

However, in radar, the targeted reflector is generally designed to be undetected. In fact, the targeted reflector is usually designed to reflect back as little power as possible to the radar's receiving antenna. For this reason, the above radar model, assumes a worst-case scenario where the reflector (103) is assumed to turn the incident wave (101) into an isotropic point source (105). That is why the distances dₜ and dᵣ are multiplied by one another.

On the other hand, the targeted reflector (103) is designed to reflect back as much power as possible. Therefore, a more adequate model for the reflector is as follows:

$${P}_{r} = {{P}_{t} ( \frac{λ}{4 π ( {d}_{t} + {d}_{r} )} )}^{2} {G}_{t} {G}_{r} η \qquad ( 3 )$$

where
Pₜ is the transmitted power from A_{T} (106);
Pᵣ is the received power at A_{R}(107);
Gᵣ is the antenna gain for A_{T}(106);
Gᵣ is the antenna gain for A_{R} (107);
dₜ is the length of the direct path (101) between A_{T} (106) and the reflector (103);
dᵣ is the length of the direct path (105) between the reflector (103) and A_{R}(107):
λ is the wavelength of the transmitted wave (101) and reflected wave 9105); and
η is the reflection power efficiency of the wave reflector (103) defined as the ratio between reflected power to incident power.

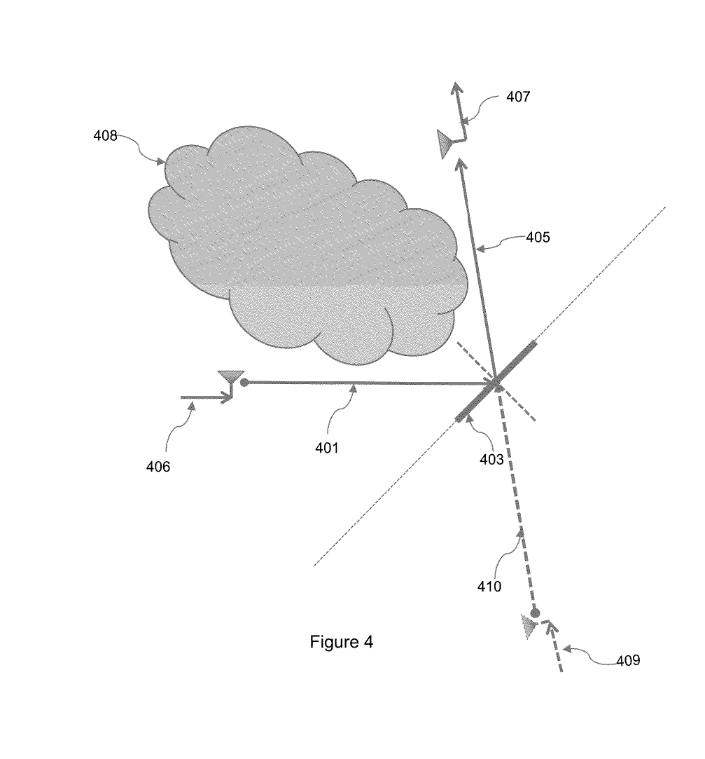

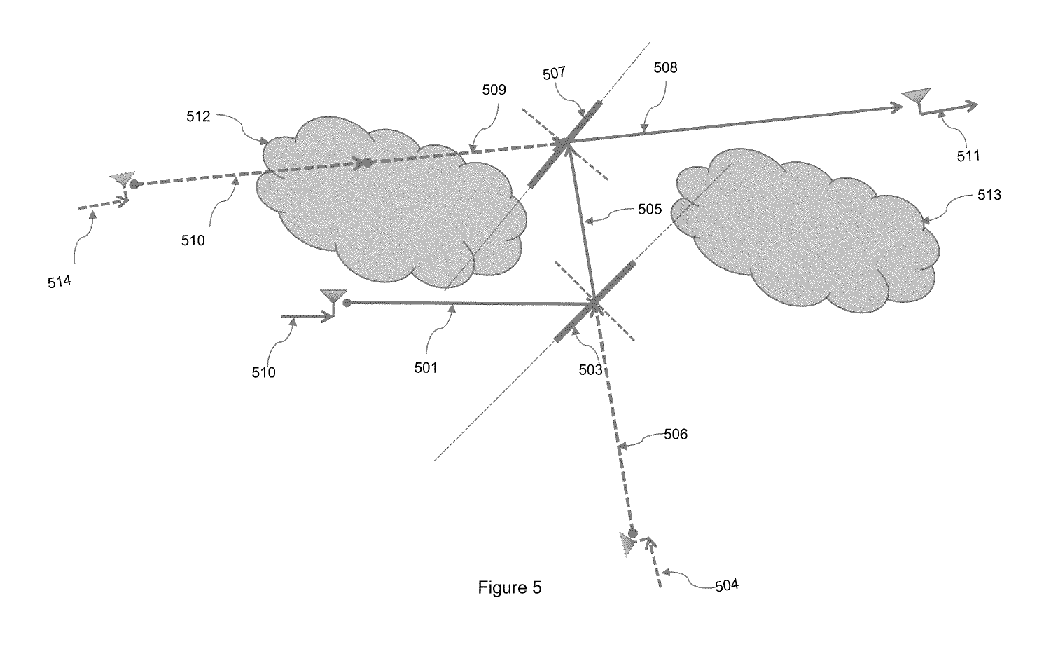

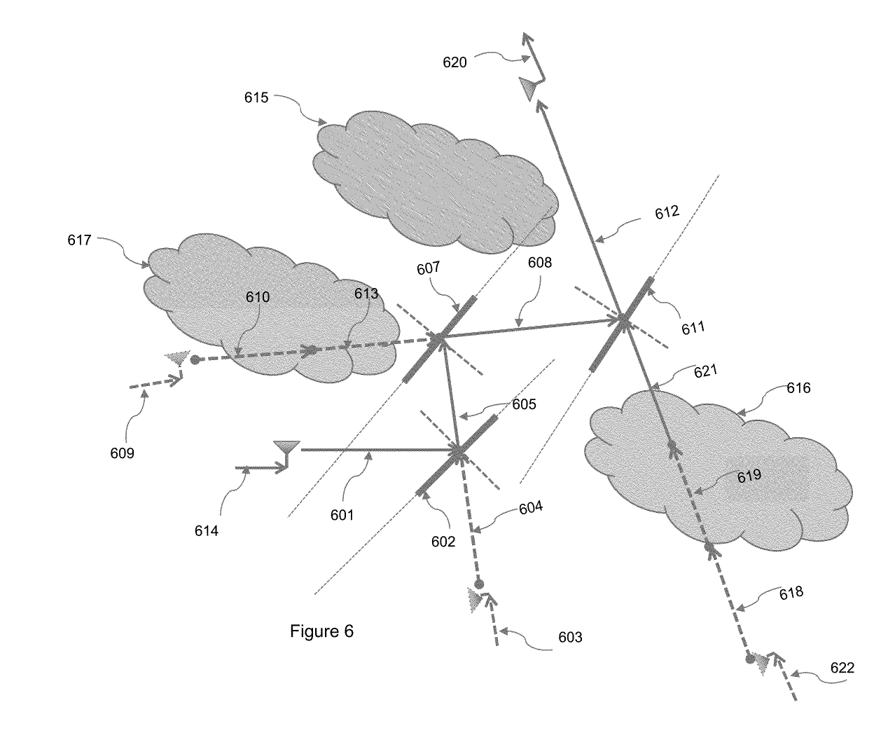

The model in Equation (3) assumes that the wave reflector reflects back the incident wave (101) with a power efficiency, η, similar to a mirror, and not similar to an isotropic point source. In other words, when the incident signal on the reflector is made up of locally substantially planar waves, the reflected signal from the reflector is also made up of locally substantially planar waves as long as the reflector is “designed properly.” In this document. “planar” will hereafter be used to denote “locally substantially planar.” For example, when the wave bender is composed of one properly designed reflector, the reflected image (409) in FIG. 4 of the transmitting antenna gives the illusion of a direct path (410, 405) between A_{T} and A_{R} that is made up of planar waves. When the wave bender is composed of two properly designed reflectors, the reflected image (514) in FIG. 5 of the transmitting antenna gives the illusion of a direct path (512, 509, 508) between A_{T} and A_{R} that is made up of planar waves. When the wave bender is composed of three properly designed reflectors, the reflected image (609) in FIG. 6 of the transmitting antenna gives the illusion of a direct path (618, 619, 621, 612) between A_{T} and A_{R} that is made up of planar waves.

In summary to this section, a reflector is said to be “designed properly” if Equation (3) applies instead of Equation (2). The model in Equation (3) is in contrast with the model in Equation (2) where the reflected signal from the reflector behaves as a point source even if the incident signal on the reflector is made up of planar waves. The combined effect of having a point source at the transmitting antenna A_{T} (106) and another point source at the reflector (103) is to multiply the distance, dₜ, between the direct path (101) between A_{T} (106) and the reflector (103) with the distance, dᵣ, of the direct path (105) between the reflector (103) and the receiving antenna, A_{R} (107). This multiplication forces the received power. Pᵣ, to be excessively low, especially when dₜ and dᵣ are large. To counteract the effect of having an excessively low received power, Pᵣ, σ in Equation (2) must be selected to be excessively high, or equivalently, the physical area of the reflector must be selected to be excessively large. In other words, a lightweight, easy to deploy passive reflector repeater is impossible to achieve if the reflector is “not designed properly.”

There is disclosed how to properly design the reflector such that Equation (3) applies, instead of Equation (2), and that a lightweight, easy to deploy reflector is feasible. A proper design of the reflector is explained after we discuss the factors affecting the efficiency q of the reflector.

Several factors affect the efficiency, q, of the reflector such as:

the footprint of the incident wave (101) on the reflector (103);

the effective incident area, Aᵢ₁, of the reflector (103) as seen by the incident wave (101);

the reflectivity of the reflector (103);

the effective reflected area, Aᵣ₁, of the reflector (103) as seen by the outgoing wave (105); and

the footprint of the incident wave (105) on A_{R} (107).

The reflection efficiency, η, can be made high as long as the following constraints are satisfied:

Constraint a1: The reflector (103) is contained within the 3 dB-beamwidth of A_{T} (106). One way to fulfill such a constraint is to point the +3 dB beam of the transmitting antenna A_{T} (106) towards the center of the reflector (103), and to place the reflector (103) in the far field of the transmitting antenna (106);

Constraint b1: The reflector (103) is contained within the 3 dB-beamwidth of A_{R} (107). One way to fulfill such a constraint is to point the ±3 dB beam of the receiving antenna A_{R} (107) towards the center of the reflector (103), and to place the reflector (103) in the far field of the receiving antenna (107);

Constraint c1: The effective incident area, Aᵢ₁, of the reflector (103) relative to the incident wave (101) is >>λ². One way to fulfill such a constraint is to select the reflector to have an “incident minor radius” bᵢ₁>λ/\sqrt{π} and an incident major radius” aᵢ₁>λ/\sqrt{π}, assuming that the reflector is “seen” by the transmitting antenna A_{T} (106) to be elliptical in shape with a minor radius bᵢ₁ and a major radius aᵢ₁. This constraint should not be understood to limit the shape of the reflector as seen by the transmitting antenna to an elliptical shape. For example, when the reflector is “seen” by the transmitting antenna A_{T} (106) to be rectangular in shape, its “incident width” Wᵢ₁ and “incident height” Hᵢ₁ must both comply with the constraint that bᵢ₁>λ/\sqrt{π} and aᵢ₁>λ/\sqrt{π}, or equivalently that Wᵢ₁/\sqrt{π}>bᵢ₁ and Hᵢ₁/\sqrt{π}>bᵢ₁. In conclusion to this constraint, regardless of the shape of the reflector, it must be seen by the transmitting antenna A_{T} (106) to contain an ellipse of minor radius bᵢ₁ and of major radius aᵢ₁;

Constraint d1: The effective reflected area, Aᵣ₁, of the reflector relative to the reflected wave (105) is >>λ². One way to fulfill such a constraint is to select the reflector to have a “reflected minor radius” bᵣ₁>λ/\sqrt{π} and a reflected major radius” aᵣ₁>λ/\sqrt{π}, assuming that the reflector is “seen” by the receiving antenna A_{R} (107) to be elliptical in shape with a minor radius bᵣ₁ and a major radius aᵣ₁. This constraint should not be understood to limit the shape of the reflector as seen by the receiving antenna to an elliptical shape. For example, when the reflector is “seen” by the receiving antenna A_{R} (107) to be rectangular in shape, its “reflected width” Wᵣ₁ and “reflected height” Hᵣ₁ must both comply with the constraint that bᵣ₁>λ/\sqrt{π} and aᵣ₁>λ/\sqrt{π}, or equivalently that Wᵣ₁/\sqrt{π} and Hᵣ₁/\sqrt{π}>bᵣ₁. In conclusion to this constraint, regardless of the shape of the reflector, it must be seen by the receiving antenna A_{R} (107) to contain an ellipse of minor radius bᵣ₁ and of major radius aᵣ₁; and

Constraint e1: The reflectivity of the reflector is ≈1 where reflectivity is defined as the ratio between the reflected power to absorbed power.

Wave Bender with One 2D-Reflector: In FIG. 1a, the effective incident area, Aᵢ₁, of the reflector (103) relative to A_{T} is equal to Aᵢ₁=A₁ sin(θ₁) where A₁ is the physical area of the reflector (103) and θ₁ (102) is the incident angle from A_{T} to the reflector (103), while the effective reflected area, Aᵣ₁, of the reflector (103) relative to A_{R} is equal to Aᵣ₁=A₁ sin(α₂−θ₁) where α₂ (104) is the desired angle for bending the incident wave (101) to a reflected wave (105).

It can be easily shown that the relationship between θ₁ (102) and α₂ (104) is such that θ₁=(α₂)/2. Therefore, Aᵢ₁=Aᵣ₁=A₁ sin(θ₁). This relationship together with constraints c1 and d1 above imply that the reflector (103) must be designed such that Aᵢ₁=Aᵣ₁=A₁ sin(θ₁)>>λ².

Wave Bender with One 3D-Reflector: In FIG. 1b, the effective incident area, Aᵢ₁, of the reflector (103) relative to A_{T} is equal to Aᵢ₁=A₁ sin(θ₁) where A₁ is the physical area of the reflector (103) and θ₁ (102) is the incident angle from A_{T} to the reflector (103), while the effective reflected area, Aᵣ₁, of the reflector (103) relative to A_{R} is equal to Aᵣ₁=A₁ sin(α₂−θ₁) where α₂ (104) is the desired angle for bending the incident wave (101) to a reflected wave (105).

It can be easily shown once again that the relationship between θ₁ (102) and α₂ (104) in FIG. 1b is such that θ₁=(α₂)/2. Therefore. Aᵢ₁=Aᵣ₁=A₁ sin(θ₁). This relationship together with constraints c1 and d1 above imply that the reflector (103) must be designed such that Aᵢ₁=Aᵣ₁=A₁ sin(θ₁)>>λ².

Even though FIG. 1b is a 3-dimensional (3D) wave bender, θ₁=(α₂)/2 is still valid in the wave plane that is made-up of the incident wave (101) and of the reflected wave (105) regardless of the shape of the reflector (103). In other words. Aᵢ₁=Aᵣ₁=A₁ sin(θ₁) is still valid where θ₁ is obtained from the following relationship: cos(π−2θ₁)=−cos(2θ₁)=cos(φ₂)cos(γ₂) where φ₂ is the horizontal angle shift corresponding to α₂ while γ₂ is the vertical angle shift corresponding to α₂ regardless of the shape of the reflector (103) and whether the wave plane that is perpendicular to the reflector (103) is horizontal or not.

Wave Bender with Two 2D-Reflectors: In FIG. 2, the effective incident area, Aᵢ₁, of the first reflector (203) relative to A_{T} is equal to Aᵢ₁=A₁ sin(θ₁) where A₁ is the physical area of the first reflector (203) and θ₁ (202) is the incident angle from A_{T} to the first reflector (203), while the effective reflected area, Aᵣ₁, of the first reflector (203) relative to the second reflector (207) is equal to Aᵣ₁=A₁ sin(α₂−θ₁) where α₂ (104) is the desired angle for bending the incident wave (201) to a reflected wave (205). It can be easily shown that the relationship between θ₁ (202) and α₂ (204) is such that θ₁=(α₂)/2. Therefore. Aᵢ₁=Aᵣ₁=A₁ sin(θ₁). This relationship together with constraints c1 and d1 above imply that the first reflector (203) must be designed such that Aᵢ₁=Aᵣ₁=A₁ sin(θ₁)>>λ².

In FIG. 2, the effective incident area, Aᵢ₂, of the second reflector (207) relative to wave (205) is equal to Aᵢ₂=A₂ sin(θ₂) where A₂ is the physical area of the second reflector (207) and θ₂ (206) is the incident angle from the first reflector (203) to the second reflector (207), while the effective reflected area, Aᵣ₂, of the second reflector (207) relative to A_{R} is equal to Aᵣ₂=A₂ sin(−(a₃−α₂)−θ₂) where α₃ (209) is the desired angle for bending the incident wave (201) to a reflected wave (208). It can be easily shown that the relationship between θ₂ (206), α₂ (204) and α₃ (209) is such that θ₂=−(a₃−α₂)/2, then Aᵢ₂=Aᵣ₂=A₂ sin(θ₂). This relationship together with constraints c1 and d1 above imply that the second reflector (207) must be designed such that Aᵢ₂=Aᵣ₂=A₂ sin(θ₂)>>λ².

Wave Bender with Two 3D-Reflectors: In FIG. 2, the effective incident area, Aᵢ₁, of the first reflector (203) relative to A_{T} is equal to Aᵢ₁=A₁ sin(θ₁) where A₁ is the physical area of the first reflector (203) and θ₁ (202) is the incident angle from A_{T} to the first reflector (203), while the effective reflected area, Aᵣ₁, of the first reflector (203) relative to the second reflector (207) is equal to Aᵣ₁=A₁ sin(α₂−θ₁) where α₂ (104) is the desired angle for bending the incident wave (201) to a reflected wave (205). It can be easily shown that the relationship between θ₁ (202) and α₂ (204) is such that θ₁=(α₂)/2, then Aᵢ₁=Aᵣ₁=A₁ sin(θ₁). This relationship together with constraints c1 and d1 above imply that the first reflector (203) must be designed such that Aᵢ₁=Aᵣ₁=A₁ sin(θ₁)>>λ².

Even though the wave bender is 3-dimensional (3D), θ₁=(α₂)/2 is still valid in the wave plane made-up of the incident wave (201) and the reflected wave (205). In other words, Aᵢ₁=Aᵣ₁=A₁ sin(θ₁) is still valid where θ₁ is obtained from the following relationship: cos(π−2θ₁)=−cos(2θ₁)=cos(φ₂)cos(γ₂) where φ₂ is the horizontal angle shift corresponding to α₂ while γ₂ is the vertical angle shift corresponding to α₂.

In FIG. 2, the effective incident area, Aᵢ₂, of the second reflector (207) relative to wave (205) is equal to Aᵢ₂=A₂ sin(θ₂) where A₂ is the physical area of the second reflector (207) and θ₂ (206) is the incident angle from the first reflector (203) to the second reflector (207), while the effective reflected area, Aᵣ₂, of the second reflector (207) relative to A_{R} is equal to Aᵣ₂=A₂ sin(−(α₃−α₂)−θ₂) where α₃ (209) is the desired angle for bending the incident wave (201) to a reflected wave (208). It can be easily shown that the relationship between θ₂ (206), α₂ (204) and α₃ (209) is such that θ₂=−(a₃−α₂)/2, then Aᵢ₂=Aᵣ₂=A₂ sin(θ₂). This relationship together with constraints c1 and d1 above imply that the second reflector (207) must be designed such that Aᵢ₂=Aᵣ₂=A₂ sin(θ₂)>>λ².

Even though the wave bender is 3-dimensional (3D), θ₂=(α₃)/2 is still valid in the wave plane made-up of the incident wave (205) and the reflected wave (208). In other words. Aᵢ₂=Aᵣ₂=A₂ sin(θ₂) is still valid where θ₂ is obtained from the following relationship: cos(π−2θ₂)=−cos(2θ₂)=cos(φ₃)cos(γ₃) where β₃ is the horizontal angle shift corresponding to α₃ while γ₃ is the vertical angle shift corresponding to α₃.

Wave Bender with Three 2D-Reflectors: In FIG. 3, the effective incident area, Aᵢ₁, of the first reflector (303) relative to A_{T} is equal to Aᵢ₁=A₁ sin(θ₁) where A₁ is the physical area of the first reflector (303) and θ₁ (302) is the incident angle from A_{T} to the first reflector (303), while the effective reflected area, Aᵣ₁, of the first reflector (303) relative to the second reflector (307) is equal to Aᵣ₁=A₁ sin(α₂−θ₁) where α₂ (104) is the desired angle for bending the incident wave (301) to a reflected wave (305). It can be easily shown that the relationship between θ₁ (302) and α₂ (304) is such that θ₁=(α₂)/2, then Aᵢ₁=Aᵣ₁=A₁ sin(θ₁). This relationship together with constraints c1 and d1 above imply that the first reflector (303) must be designed such that Aᵢ₁=Aᵣ₁=A₁ sin(θ₁)>>λ².

In FIG. 3, the effective incident area, Aᵢ₂, of the second reflector (307) relative to wave (305) is equal to Aᵢ₂=A₂ sin(θ₂) where A₂ is the physical area of the second reflector (307) and 02 (306) is the incident angle from the first reflector (303) to the second reflector (307), while the effective reflected area, Aᵣ₂, of the second reflector (307) relative to the third reflector (311) is equal to Aᵣ₂=A₁ sin(−(α₃−α₂)−θ₂) where α₃ (309) is the desired angle for bending the incident wave (305) to a reflected wave (308). If the relationship between θ₂ (306), α₂ (34) and α₃ (309) is such that θ₂=−(α₃−α₂)/2, then Aᵢ₂=Aᵣ₂=A₂ sin(θ₂). This relationship together with constraints c1 and d1 above imply that the second reflector (307) must be designed such that A₂ sin(θ₂)>>λ².

In FIG. 3, the effective incident area, Aᵢ₃, of the third reflector (311) relative to wave (308) is equal to Aᵢ₃=A₃ sin(θ₃) where A₃ is the physical area of the third reflector (311) and θ₃ (310) is the incident angle from the second reflector (307) to the third reflector (311), while the effective reflected area, Aᵣ₃, of the third reflector (103) relative to A_{R} (315) is equal to Aᵣ₃=A₃ sin((α₄−α₃)−θ₃) where α₄ (313) is the desired angle for bending the incident wave (308) to a reflected wave (312). If the relationship between θ₃ (310), α₃ (309) and α₄ (313) is such that θ₃=(α₄−α₃)/2, then Aᵢ₃=Aᵣ₃=A₃ sin(θ₃). This relationship together with constraints c1 and d1 above imply that the third reflector (311) must be designed such that Aᵢ₃=Aᵣ₃=A₃ sin(θ₃)>>λ².

Wave Bender with Three 3D-Reflectors: In FIG. 3, the effective incident area, Aᵢ₁, of the first reflector (303) relative to A_{T} is equal to Aᵢ₁=A₁ sin(θ₁) where A₁ is the physical area of the first reflector (303) and θ₁ (302) is the incident angle from A_{T} to the first reflector (303), while the effective reflected area, Aᵣ₁, of the first reflector (303) relative to the second reflector (307) is equal to Aᵣ₁=A₁ sin(α₂−θ₁) where α₂ (104) is the desired angle for bending the incident wave (301) to a reflected wave (305). It can be easily shown that the relationship between θ₁ (302) and α₂ (304) is such that θ₁=(α₂)/2, then Aᵢ₁=Aᵣ₁=A₁ sin(θ₁). This relationship together with constraints c1 and d1 above imply that the first reflector (303) must be designed such that Aᵢ₁=Aᵣ₁=A₁ sin(θ₁)>>λ².

Even though the wave bender is 3-dimensional (3D), θ₁=(α₂)/2 is still valid in the wave plane made-up of the incident wave (301) and the reflected wave (305). In other words, Aᵢ₁=Aᵣ₁=A₁ sin(θ₁) is still valid where θ₁ is obtained from the relationship cos(π−2θ₁)=−cos(2θ₁)=cos(φ₂)cos(γ₂) where θ₂ is the horizontal angle shift corresponding to α₂ while γ₂ is the vertical angle shift corresponding to α₂.

In FIG. 3, the effective incident area, Aᵢ₂, of the second reflector (307) relative to wave (305) is equal to Aᵢ₂=A₂ sin(θ₂) where A₂ is the physical area of the second reflector (307) and θ₂ (306) is the incident angle from the first reflector (303) to the second reflector (307), while the effective reflected area, Aᵣ₂, of the second reflector (307) relative to the third reflector (311) is equal to Aᵣ₂=A₁ sin(−(α₃−α₂)−θ₂) where α₃ (309) is the desired angle for bending the incident wave (305) to a reflected wave (308). It can be easily shown that the relationship between θ₂ (306), α₂ (304) and α₃ (309) is such that θ₂=−(α₃−α₂)/2, then Aᵢ₂=Aᵣ₂=A₂ sin(θ₂). This relationship together with constraints c1 and d1 above imply that the second reflector (307) must be designed such that A₂ sin(θ₂)>>λ².

Even though the wave bender is 3-dimensional (3D), θ₂=(α₃)/2 is still valid in the plane made-up of the incident wave (305) and the reflected wave (308). In other words. Aᵢ₂=Aᵣ₂=A₂ sin(θ₂) is still valid where θ₂ is obtained from the following relationship: cos(π−2θ₂)=−cos(2θ₂)=cos(φ₃)cos(γ₃) where φ₃ is the horizontal angle shift corresponding to α₃ while γ₃ is the vertical angle shift corresponding to α₃.

In FIG. 3, the effective incident area, Aᵢ₃, of the third reflector (311) relative to wave (308) is equal to Aᵢ₃=A₃ sin(θ₃) where A₃ is the physical area of the third reflector (311) and θ₃ (310) is the incident angle from the second reflector (307) to the third reflector (311), while the effective reflected area, Aᵣ₃, of the third reflector (103) relative to A_{R} (315) is equal to Aᵣ₃=A₃ sin((α₄−α₃)−θ₃) where α₄ (313) is the desired angle for bending the incident wave (308) to a reflected wave (312). It can be easily shown that the relationship between θ₃ (310), α₃ (309) and α₄ (313) is such that θ₃=(α₄−α₃)/2, then Aᵢ₃=Aᵣ₃=A₃ sin(θ₃). This relationship together with constraints c1 and d1 above imply that the third reflector (311) must be designed such that Aᵢ₃=Aᵣ₃=A₃ sin(θ₃)>>λ².

Even though the wave bender is 3-dimensional (3D), θ₃=(α₄)/2 is still valid in the plane made-up of the incident wave (308) and the reflected wave (312). In other words, Aᵢ₃=Aᵣ₃=A₃ sin(θ₃) is still valid where θ₃ is obtained from the relationship cos(π−2θ₃)=−cos(2θ₃)=cos(φ₄)cos(γ₄) where φ₄ is the horizontal angle shift corresponding to α₄ while γ₄ is the vertical angle shift corresponding to α₄.

Wave Bender with N 2D-Reflectors: In general, it can be easily shown that for a wave bender with N reflectors, the 2-dimensional relationship between the incident angle, θₙ, corresponding to the n^{th} reflector, and the reflected angle, αₙ, corresponding to the n^{th} reflector must be

θₙ=(−1)ⁿ⁺¹(αₙ−αₙ₋₁)/2 for n=1, . . . , N (4a)

Without loss of generality, the reflected angle, α₁, in Equation (4a) for the first reflector is selected as a reference, i.e, α₁=0, for the 2-dimensional deployment of a wave bender with N reflectors.

Wave Bender with N 3D-Reflectors: In general, it can be easily shown that for a wave bender with N reflectors, the relationship between the incident angle, θₙ, corresponding to the n^{th} reflector, and the reflected angle, αₙ, corresponding to the n^{th} reflector is

θₙ=(−1)ⁿ⁺¹(αₙ−αₙ₋₁)/2 for n=1, . . . , N (4b)

Even though the wave bender is 3-dimensional (3D), Equation (4b) is still valid in the wave plane made-up of the n^{th} incident wave (308) and the n^{th} reflected wave (312). In other words, Aᵢₙ=Aᵣₙ=Aₙ sin(θₙ) is still valid where θₙ is obtained from the relationship cos(π−2θₙ)=−cos(2θₙ)=cos(φₙ₊₁)cos(γₙ₊₁) where φₙ₊₁ is the horizontal angle shift corresponding to αₙ₊₁ while γₙ₊₁ is the vertical angle shift corresponding to aₙ₊₁.

Without loss of generality, the reflected angle, α₁, in Equation (4b) for the first reflector is selected as a reference, i.e, α₁=0, for the 2-dimensional deployment of a wave bender with N reflectors.

Practical Design Considerations for Properly Designed Reflectors: Important practical design considerations for meeting the 5 constraints a1, b1, c1, d1 and e1 are discussed here. In order for the wave bender to be easily deployed, its elements, the reflectors, must be lightweight, small in size and easy to configure. On the other hand, in order for the wave bender to require low maintenance, its elements must be passive (i.e. no power source), withstand heavy wind loading and are unaffected by severe weather conditions.

The “small in size” requirement for the reflectors directly affects the two constraints c1 and d1. As previously mentioned, Equation (2) implies a received signal at A_{R} with very low power, Pᵣ. That is why all previous designs of passive reflector repeaters selected the physical area of the reflectors, A, to be quite large in order to compensate for the weak received signal. From Equation (3), one can meet constraints c1 and d1 without selecting an excessively large reflector, as long as

Aᵢₙ=Aᵣₙ=Aₙ sin(θₙ)>>λ², for n=1, . . . , N.

The “easy to configure” requirement for the reflectors directly affects the two constraints a1 and b1. However, the two constraints are easily met using a single flat mirror at every reflector to be configured using Method I as follows:

Method I:

a) Select the number N of the required reflectors and their location using Method II below.
b) Point the ±3 dB beam of the transmitting antenna A_{T} towards the center of the first reflector, where the first reflector is placed in the far field of the transmitting antenna.
c) Place the flat mirror at the center of the first reflector.
d) Position a viewer to have his/her back perpendicular to the corresponding incident wave.
e) Ask the viewer to look at the image formed by the mirror.
f) Adjust the reflector either in a 2-dimensional fashion or in a 3-dimensional fashion until the formed image that is viewed by the viewer is that of the next reflector.
g) Repeat steps b) to e) for every reflector, until you reach the last reflector. In this case, the following steps must be followed:
h) Place the flat mirror at the center of the last reflector.
i) Position a viewer to have his/her back perpendicular to the corresponding incident wave.
j) Ask the viewer to look at the image formed by the mirror.
k) Adjust the reflector either in a 2-dimensional fashion or in a 3-dimensional fashion until the formed image that is viewed by the viewer is that of the receiving antenna A_{R}.
l) Point the ±3 dB beam of the receiving antenna A_{R} towards the center of the last reflector.

Although a “viewer” is referred to as if it were a person, the “viewer” can also be an automatic device or a viewing device used by a person. The notion of viewing can be extended to the notion of “sighting” where sighting an object along a line can be either viewing the object in a direction along the line or sending a beam of light in the direction of the object along the line (see method IV below). Similarly, sighting an object in a mirror can be seeing an image of the object in the mirror or reflecting light from the mirror to the object.

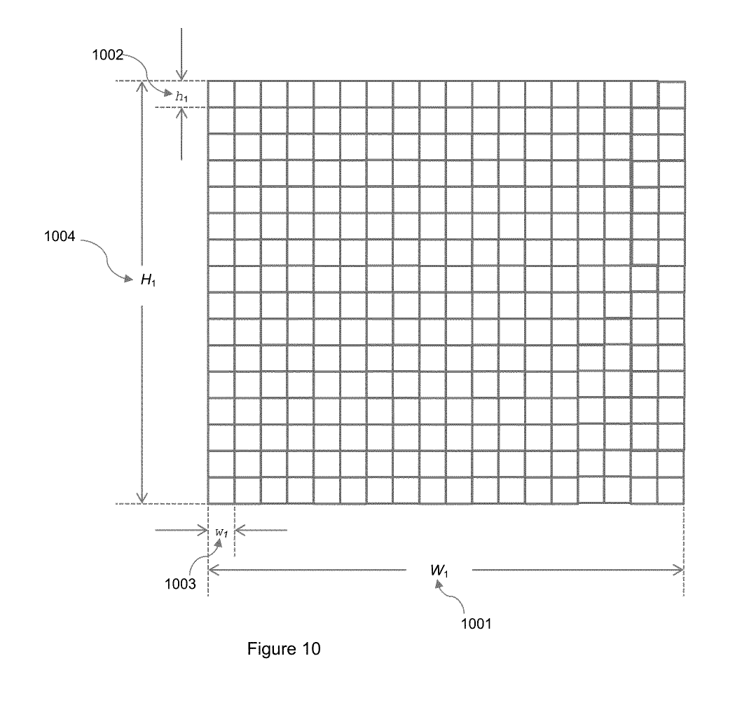

The “lightweight” requirement for the reflectors together with the “able to withstand heavy wind loading” requirement also for the reflectors, directly affect constraint e1. In order to meet constraint e1, while keeping the weight light and the wind loading low, a grid metallic structure for the reflectors may be selected as shown in FIGS. (7), (8), (9) and (10). In FIG. 10, a rectangular grid structure is shown as a preferred embodiment of the reflector. In FIG. 10, the rectangular grid structure has a physical width Wₙ (1001) and a physical height Hₙ (1004). Also, in FIG. 10, the eyes of the grid are rectangular with a width wₙ (1003) and a height hₙ (1002). In order to satisfy constraint e1, we must have

Aᵢₙ=Aᵣₙ=Aₙ sin(θₙ)=Wₙ×Hₙ sin(θₙ)>>λ², or equivalently

Wₙ\sqrt{sin(θ₁)}>λ and Hₙ\sqrt{sin(θ₁)}>λ; and

[symbol]

[symbol]

wₙ×hₙ<<λ², or equivalently

wₙ<λ and hₙ<λ.

As previously mentioned, the rectangular grid structure in FIG. 10 can be generalized to take any structure. For example, an elliptical structure with a minor radius b₁ and a major radius α₁ corresponds to an area A₁=πb₁a₁, or equivalently A₁ sin(θ₁)=πb₁α₁ sin(θ₁)>>λ², i.e. b₁\sqrt{sin(θ₁)}>λ/\sqrt{π} and a₁\sqrt{sin(θ₁)}>λ/\sqrt{π}.

In general, the 2D rectangular grid structure shown as a preferred embodiment of the reflector in FIG. 10 can be generalized to take any 3D shape, which contains a rectangular shape of area A₁. In this case, we need to define an equivalent width. W_{eq,1}, and an equivalent height, H_{eq,1}, of the new shape to have their product equal to A₁, i.e.

A₁ [symbol] W_{eq,1}×H_{eq,1} (5a)

Similarly, the 2D rectangular grid structure shown as a preferred embodiment of the reflector in FIG. 10 can be generalized to take any 3D shape, which contains an elliptical structure. In this case, we need to define an equivalent minor radius, b_{eq,1} and an equivalent major radius, a_{eq,1} of the new shape as

A₁ [symbol] πb_{eq,1}a_{eq,1} (5b)

Furthermore, the eyes of the grid can be generalized to take any shape. For example, the eyes of the grid can take a shape, which contains a rectangular shape. Once again, we need to define an equivalent width, w_{eq,1}, and an equivalent height, h_{eq,1}, of the new shape to have their product equal to [symbol] ₁, i.e.

[symbol]

₁ [symbol] w_{eq,1}×h_{eq,1} (6a)

Similarly, the eyes of the grid can take a shape, which contains an elliptical shape. Once again, we need to define an equivalent minor radius, b_{eq,1}, and an equivalent major radius, a_{eq,2}, of the new shape as

[symbol]

₁ [symbol] πb_{eq,1}a_{eq,1} (6b)

In conclusion to this design consideration, to satisfy constraint e1, we must have

Aᵢ₁=Aᵣ₁=A₁ sin(θ₁)=W_{eq,1}×H_{eq,1} sin(θ₁)>>λ², or equivalently

W_{eq,1}\sqrt{sin(θ₁)}>λ and H_{eq,1}\sqrt{sin(θ₁)}>λ (7a)

[symbol]

₁ [symbol] w_{eq,1}×h_{eq,1}<<λ², or equivalently

w_{eq,1}<λ and h_{eq,1}<λ (8a)

Alternatively, to satisfy constraint e1, we must have

Aᵢ₁=Aᵣ₁=A₁ sin(θ₁)=πb_{eq,1}a_{eq,1} sin(θ₁)>>λ², or equivalently

b_{eq,1}\sqrt{sin(θ₁)}>λ/π and a_{eq,1}\sqrt{sin(θ₁)}>λ/π (7b)

[symbol]

₁=πb_{eq,1}a_{eq,1}<<λ², or equivalently

b_{eq,1}<λ/π and a_{eq,1}<λ/π (8b)

### DESCRIPTION OF THE PREFERRED EMBODIMENTS

Method II

There is disclosed a method, we refer to as Method II, for selecting the number, N, of properly designed reflectors in a wave bender, and their location. The method follows an iterative approach, which starts by selecting the number of reflectors to be one and to check if all above constrains a1, b1, c1, d1 and e1 are satisfied based on a number of appropriate locations for the reflector. If they are, then the method ends, otherwise, the number of reflectors is incremented by one and the steps are repeated one more time. The iterative approach carries on until all constraints are satisfied, or an upper limit on the number of reflectors is reached. In order to limit the number of options that are available, the following assumptions are made:

Assumption A1: All N reflectors are designed properly.

Assumption A2: The deployment is a 2-dimensional deployment. This assumption is easily extended to include a 3-dimensional deployment.

Assumption A3: The locations of the transmitting antenna, A_{T}, receiving antenna, A_{R}, and obstacles are known, i.e. the desired angle bending, α_{N+1}, between A_{T} and A_{R} is known once the location of the wave bender is known.

Assumption A4: The wave bender is composed of reflectors that are made of a material, which satisfies constraint e1.

Assumption A5: The reflectors are all flat, and either rectangular or elliptical in shape. This assumption is easily extended to include any 3-dimensional shape of the reflector.

Assumption A6: The “method to configure a reflector to comply with constraints a1 and b1” (above) is met.

Assumption A7: When the n^{th} reflector is assumed to be flat and rectangular, and when its equivalent width, W_{eq,n}, and its equivalent height, H_{eq,n}, are both larger than 4 times the wavelength, i.e. when W_{eq,n}≧4λ and H_{eq,n}≧4λ, constrains c1 and d1 are assumed to be satisfied for all value of n=1, . . . , N. Alternatively, when the n^{th} reflector is assumed to be flat and elliptical, and when its equivalent minor radius, b_{eq,n}, and its equivalent major radius, a_{eq,n}, are both larger than 4 times the wavelength/\sqrt{π}, i.e. when b_{eq,n}≧4λ/\sqrt{π} and a_{eq,n}≧4λ/\sqrt{π}, constrains c1 and d1 are assumed to be satisfied for all value of n=1, . . . , N.

The above assumptions are further discussed (and sometimes relaxed) later in the disclosure.

The following are the iterations (and corresponding steps) of Method II, which applies to both 2D and 3D wave benders:

First Iteration:

Step 1,1: Select N=1 which corresponds to using one reflector.

Step 1,2: Find all acceptable locations for the reflector such that there is a direct Line-of-Sight (LOS) between the reflector and both the transmitting antenna, A_{T}, and the receiving antenna, A_{R}. If this is not possible, go to Step 2,1.

Step 1,3: For each acceptable location for the reflector, solve for θ₁ using the relationship: θ₁=(α₂−α₁)/2 where α₁=0 and α₂, the desired angle bending between the wave transmitted by A_{T} and the wave received by A_{R}, is known from assumption A2, (or equivalently both φ₂ and γ₂ are known in a 3D deployment).

Step 1,4: For each acceptable location for the reflector, solve for the effective width, W_{e,1}, and effective height H_{e,1} for the first reflector using the relationship: W_{e,1}=W_{eq,1}\sqrt{sin(θ₁)} and H_{e,1}=H_{eq,1}\sqrt{sin(θ₁)} where W_{eq,1} and H_{e,1} are the equivalent width and height of the first reflector respectively (Equation 5a) assuming that the first reflector is flat and rectangular (assumption A5). Alternatively, when the first reflector is assumed to be flat and elliptical, for each acceptable location for the reflector, solve for its effective minor radius, b_{e,1}, and for its effective major radius, a_{e,1}, using the relationship: b_{e,1}=b_{eq,1}\sqrt{sin(θ₁)} and a_{e,1}=a_{eq,1}\sqrt{sin(θ₁)} where b_{eq,1} and a_{eq,1} are the equivalent minor radius and major radius of the first reflector respectively (Equation 5b).

Step 1,5: Select all acceptable locations for the reflector where W_{e,1}≈4λ and H_{e,1}≈4λ where λ is the wavelength of the RF wave, or equivalently select all acceptable locations for the reflector where b_{e,1}≈4λ/\sqrt{π} and a_{e,1}≧4λ/\sqrt{π}. If none exists, then go to Step 2,1. Otherwise, select the acceptable location for the reflector which corresponds to an appropriate value of W_{e,1}H_{e,1}, or alternatively to an appropriate value of b_{e,1}a_{e,1}, then stop (assumption A7).

Second Iteration:

Step 2,1: Select N=2 which corresponds to using two reflectors.

Step 2,2: Find all acceptable locations for the two reflectors such that there is a direct Line-of-Sight (LOS) between the first reflector and both the transmitting antenna, A_{T}, and the second reflector, and there is a direct LOS between the second reflector and both the first reflector and the receiving antenna, A_{R}. If this is not possible, go to Step 3,1.

Step 2,3: For each acceptable location for both reflectors, solve for θ₁ such that Wₑ₁=W₁ sin(θ₁)>4λ (assumption A7).

Step 2,4: For each acceptable location for both reflectors, solve for α₂ using the relationship: θ₁=(α₂−α₁)/2 where α₁=0.

Step 2,5: For each acceptable location for both reflectors, solve for θ₂ using the relationship: θ₂=(α₃−α₂)/2 where α₃, the desired angle bending between the wave transmitted by A_{T} and the wave received by A_{R}, is known from assumption A2, (or equivalently both φ₃ and γ₃ are known in a 3D deployment).

Step 2,6: For each acceptable location for both reflectors, solve for the effective widths, W_{e,1} and W_{e,2}, for both reflectors using the relationships: W_{e,1}=W_{eq,1}\sqrt{sin(θ₁)} and W_{e,2}=W_{eq,2}\sqrt{sin(θ₁)} respectively, and the effective heights H_{e,1} and H_{e,2} for both reflectors using the relationships: H_{e,1}=H_{eq,1}\sqrt{sin(θ₁)} and H_{e,2}=H_{eq,2}\sqrt{sin(θ₂)} respectively, where W_{eq,2} and H_{e,2} are the equivalent width and height of the second reflector respectively, (Equation 5a) assuming that the second reflector is flat and rectangular (assumption A5). Alternatively, when the second reflector is assumed to be flat and elliptical, for each acceptable location for the reflector, solve for both effective minor radii, b_{e,1} and b_{e,2}, and for both effective major radii, a_{e,1} and a_{e,2}, using the relationships: b_{e,1}=b_{eq,1}\sqrt{sin(θ₁)}, a_{eq,1}=a_{eq,1}\sqrt{sin(θ₁)}, b_{e,2}=b_{eq,2}\sqrt{sin(θ₂)} and a_{e,2}=a_{eq,2}\sqrt{sin(θ₂)} where b_{eq,2} and a_{eq,2} are the equivalent minor radius and major radius of the second reflector respectively (Equation 5b).

Step 2,7: Select all acceptable locations for the reflector where W_{e,1}≧4λ. H_{e,1}≧4λ, W_{e,2}≧4λ and H_{e,2}≧4λ, or equivalently, select all acceptable locations for the reflector where b_{e,1}≧4λ/\sqrt{π}, a_{e,1}≧4λ/\sqrt{π}, b_{e,2}≧4λ/\sqrt{π} and a_{e,2}≧4λ/\sqrt{π}. If none exists, then go to Step 3,1. Otherwise, select the acceptable location for the first reflector which corresponds to appropriate value of W_{e,1}H_{e,1}, or alternatively to an appropriate value of b_{e,1}a_{e,1}, Then select the acceptable location for the second reflector which corresponds to an appropriate value of W_{e,2}H_{e,2}, or alternatively to an appropriate value of b_{e,2}a_{e,2}, then stop, (assumption A7).

Third Iteration:

Step 3,1: Select N=3 which corresponds to using three reflectors.

Step 3,2: Find all acceptable locations for the three reflectors such that (1) there is a direct Line-of-Sight (LOS) between the first reflector and both the transmitting antenna, A_{T}, and the second reflector; (2) there is a direct LOS between the second reflector and both the first reflector and the third reflector; (3) there is a direct LOS between the third reflector and both the second reflector and the receiving antenna, A_{R}. If this is not possible, go to Step N,1.

Step 3,2: For each acceptable location for all three reflectors, solve for θ₁ such that W_{e,1}=W₁ sin(θ₁)≧4λ (assumption A7).

Step 3,3: For each acceptable location for all three reflectors, solve for α₂ using the relationship: θ₁=(α₂−α₁)/2 where α₁=0.

Step 3,4: For each acceptable location for all three reflectors, solve for θ₂ such that W_{e,2}=W₂ sin(θ₂)≧4λ(assumption A7).

Step 3,5: For each acceptable location for all three reflectors, solve for α₃ using the relationship: θ₂=(α₃−α₂)/2.

Step 3,6: For each acceptable location for all three reflectors, solve for θ₃ using the relationship: θ₃=(α₄−α₃)/2 where α₄, the desired angle bending between the wave transmitted by A_{T} and the wave received by A_{R}, is known from assumption A2, (or equivalently both φ₉₄ and γ₄ are known in a 3D deployment).

Step 3,7: For each acceptable location for all three reflectors, solve for the effective widths, W_{e,1}, Wₑ₂, and W_{e,3}, and the effective heights, H_{e,1}, H_{e,2} and H_{e,3} using the relationships: W_{e,1}=W_{eq,1} \sqrt{sin(θ₁)}, W_{e,2}=W_{eq,2}\sqrt{sin(θ₂)} and W_{e,3}=W_{eq,3} \sqrt{sin(θ₃)}, H_{e,1}=H_{eq,1}\sqrt{sin(θ₁)}, H_{e,2}=H_{eq,2} \sqrt{sin(θ₂)} and H_{e,3}=H_{eq,3} \sqrt{sin(θ₃)} where W_{eq,3} and H_{e,3} are the equivalent width and height of the third reflector respectively (Equation 5a) assuming that the third reflector is flat and rectangular (assumption A5). Alternatively, when the third reflector is assumed to be flat and elliptical, for each acceptable location for the reflector, solve for all effective minor radii, b_{e,1}, b_{e,2}, and b_{e,3}, and for all effective major radii, a_{e,1}, a_{e,2}, and a_{e,3} using the relationships: b_{e,1}=b_{eq,1} \sqrt{sin(θ₁)}, a_{e,1} \sqrt{sin(θ₁)}, b_{e,2}=a_{eq,2} \sqrt{sin(θ₂)}, a_{e,2}=a_{eq,2} \sqrt{sin(θ₂)}, b_{e,3}=b_{eq,3} \sqrt{sin(θ₃)} and a_{e,3}=a_{eq,3} sin(θ₃) where b_{eq,3} and a_{eq,3} are the equivalent minor radius and major radius of the third reflector respectively (Equation 5b).

Step 3,8: Select all acceptable locations for the reflector where W_{e,1}≧4λ. H_{e,1}≧4λ, W_{e,2}≧4λ, H_{e,2}>4λ, W_{e,3}>4λ and H_{e,3}≧4λ or equivalently, select all acceptable locations for the reflector where b_{e,1}≧4λ/\sqrt{π}, a_{e,1}≧4λ/\sqrt{π}, b_{e,2}≧4λ/\sqrt{π}, a_{e,2}≈4λ/\sqrt{π}, b_{e,3}≧4λ/\sqrt{π} and a_{e,3}>4λ/\sqrt{π}. If none exists, then go to Step N,1. Otherwise, select the acceptable location for the first reflector which corresponds to appropriate value of W_{e,1}H_{e,1}, or alternatively to an appropriate value of b_{e,1}a_{e,1}. Then select the acceptable location for the second reflector which corresponds to an appropriate value of W_{e,2}H_{e,2}, or alternatively to an appropriate value of b_{e,2}a_{e,2}. Finally, select the acceptable location for the third reflector which corresponds to an appropriate value of W_{e,3}H_{e,3}, or alternatively to an appropriate value of b_{e,3}a_{e,3}, then stop, (assumption A7).

N^{th} Iteration:

Step N,1: Increment N by 1.

Step N,2: Find all acceptable locations for all N reflectors such that (1) there is a direct Line-of-Sight (LOS) between the first reflector and both the transmitting antenna, A_{T}, and the second reflector; (2) there is a direct LOS between the second reflector and both the first reflector and the third reflector; etc. (3) there is a direct LOS between the last reflector and both the second last reflector and the receiving antenna, A_{R}. If this is not possible, repeat all steps from Step N,1 to Step N,M.

Step N,2: For each acceptable location for all reflectors, solve for θ₁ such that W_{e,1}=W₁ sin(θ₁)≧4λ (assumption A7).

Step N,3: For each acceptable location for all reflectors, solve for α₂ using the relationship: θ₁=(α₂−α₁)/2 where α₁=0.

Step N,4: For each acceptable location for all reflectors, solve for θ₂ such that Wₑ₂=W₂ sin(θ₂)≧4λ (assumption A7).

Step N,5: For each acceptable location for all reflectors, solve for α₃ using the relationship: θ₂=(α₃−α₂)/2.

Step N,M−1: For each acceptable location for all reflectors, solve for ON using the relationship: θ_{N}=(α_{N+1}−α_{N})/2 where α_{N+1}, the desired angle bending between the wave transmitted by A_{T} and the wave received by A_{R}, is known from assumption A2, (or equivalently both φ_{N+1} and γ_{N+1} are known in a 3D deployment).

Step N,M−1: Solve for the effective width, W_{e,n}, and the effective height H_{e,n} for the n^{th} reflector using the relationship: W_{e,n}=W_{eq,n} \sqrt{sin(θₙ)} and H_{e,n}=H_{eq,n} \sqrt{sin(θₙ)} where W_{eq,n} and H_{eq,n} are the equivalent width and height of the n^{th} reflector respectively (Equation 5a) assuming that the n^{th} reflector is flat and rectangular (assumption A5) for all values of n. Equivalently, when the n^{th} reflector is assumed to be flat and elliptical, solve for its effective minor radius, b_{e,n}, and for its effective minor radius, a_{e,n,} using the relationship: b_{e,n}=h_{eq,n} sin(θₙ) and a_{e,n}=a_{eq,n} \sqrt{sin(θₙ)} where b_{eq,n} and a_{eq,n} are the equivalent minor radius and major radius of the n^{th} reflector respectively (Equation 5b) for all values of n.

Step N,M: Select all acceptable locations for the n^{th} reflector where W_{e,n}≧4λ, and H_{e,n}≧4λ, or equivalently, select all acceptable locations for the n^{th} reflector where b_{e,n}≧4λ/\sqrt{π}, and a_{e,n}≧4λ/\sqrt{π} for all values of n. If none exists, then repeat Step N,1 to Step N,M. Otherwise, select the acceptable location for the n^{th} reflector which corresponds to an appropriate value of W_{e,n}H_{e,n}, or alternatively to an appropriate value of b_{e,n}a_{e,n} for all values of n, then stop, (assumption A7).

Notes:

In the above method, Method II, M is equal to M=4+2(N−1).

In the above method, Method II, when Wₙ is selected equal to 60 cm for n=1, . . . , N, and the wavelength λ is selected equal to 12.5 cm (which corresponds to a carrier frequency of 2.4 GHz), then the maximum number of required reflectors is 3 and the breakdown for the angles is as follows.

When the desired angle bending, α_{N+1}, between the wave transmitted by A_{T} and the wave received by A_{K} is as follows:

1. 0<α_{N+1}≦60°, then the number N of reflector is two;
2. 60°≦α_{N+1}≦110°, then the number N of reflector is three;
3. 110°≦α_{N+1}≦180°, then the number N of reflector is one.

Selecting the location of the wave bender: Selecting an acceptable location for the n^{th} reflector to correspond to an appropriate value of W_{e,n}H_{e,n}, or alternatively to an appropriate value of b_{e,n}a_{e,n}, sometimes corresponds to having more than one solution. When there is more than one choice of placing the elements of the wave bender, the question arises of how to choose between the various choices. Usually, an important factor is the desired angle bending, α_{N+1}, between the wave transmitted by A_{T} and the wave received by A_{R}, (or equivalently φ_{N+1} and γ_{N+1} in a 3D deployment). Angle α_{N+1} is important since it determines the number of reflectors in a wave bender. The number of reflectors affects the cost and ease of deployment among other things. Another important factor when choosing the placement of the wave bender is the effective distance between the transmitting antenna A_{T} and the receiving antenna A_{R}, which is computed as the sum of all indirect paths between the two antennas. The lower the sum, the better the received SNR at A_{R}.

Selecting non-flat Reflectors in a Wave Bender: Assumption A5 assumes that the reflectors are flat. A flat properly designed reflector reflects incident planar waves as reflected planar waves. If the reflector is not flat, but curved, it reflects planar waves into non-planar waves. Most curved reflectors have surfaces that are shaped like part of a sphere, but other shapes are sometimes used. The most common non-spherical type is parabolic reflectors. Curved reflectors that are shaped like a sphere can be either convex (bulging outward) or concave (bulging inward). A convex reflector or diverging reflector is a curved reflector in which the reflective surface bulges toward the transmitting antenna A_{T}. Convex reflectors reflect planar waves outwards in a spread out manner, i.e. they are not used to focus the waves but in fact, they suffer a loss in efficiency, η. A concave or converging reflector has a reflecting surface that bulges inward (away from the incident waves). Concave reflectors reflect planar waves inward to one focal point. They are used to focus waves, and therefore offer a gain in efficiency.

From the above assessment, one can argue that a concave reflector can offer a gain in efficiency over a flat reflector, which depends on the size of the reflector. This is true. However, the deployment of concave reflectors can be complicated since one needs to place the focal point of the first concave reflector at the center of the second reflector. Nonetheless, some applications might require high gain concave reflectors.

Selecting Reflectors of any shape in a Wave Bender: Assumption A5 assumes that the reflectors are either rectangular or elliptical. This is only for convenience in manufacturing and in storing (stacking) the reflectors. A rounded reflector is as effective as a rectangular one. In fact a rounded reflector can be made lighter than a rectangular one if it does not contain corners. In other words, Assumption A5 can be simply modified to include any shape for a reflector as long as an elliptical shape is contained within the reflector.

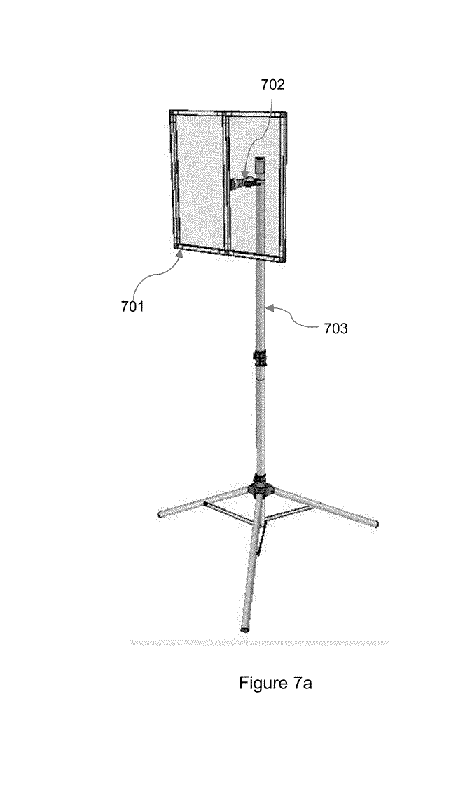

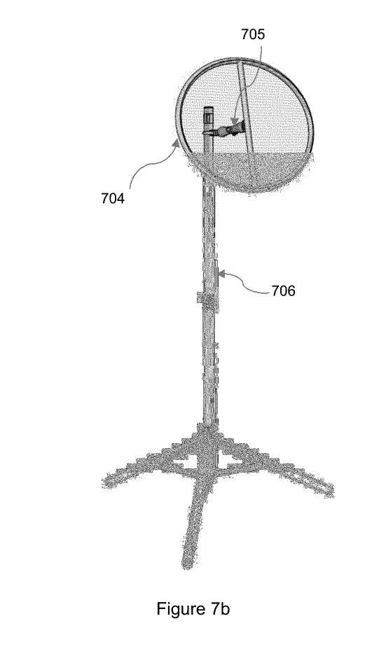

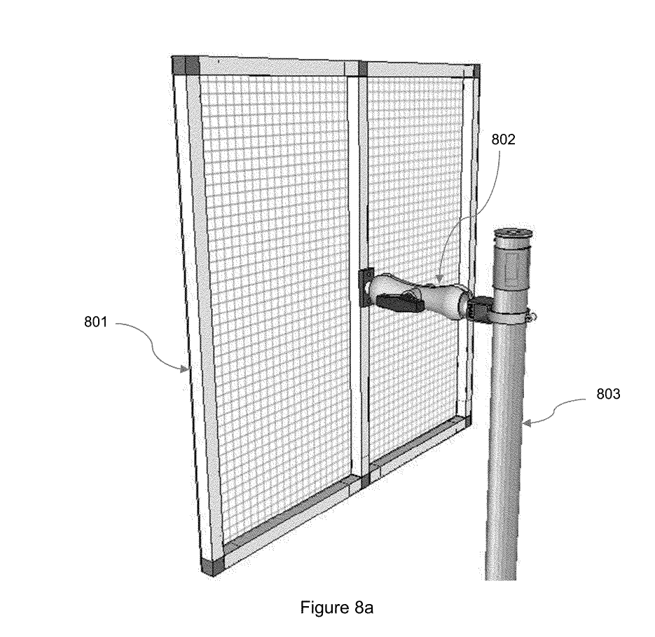

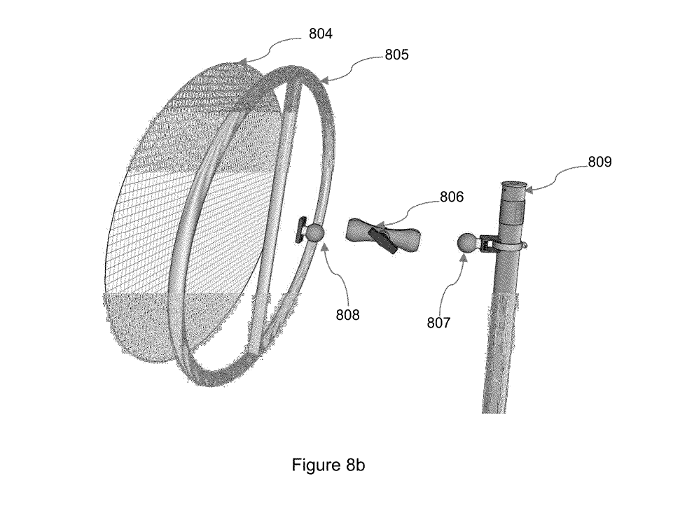

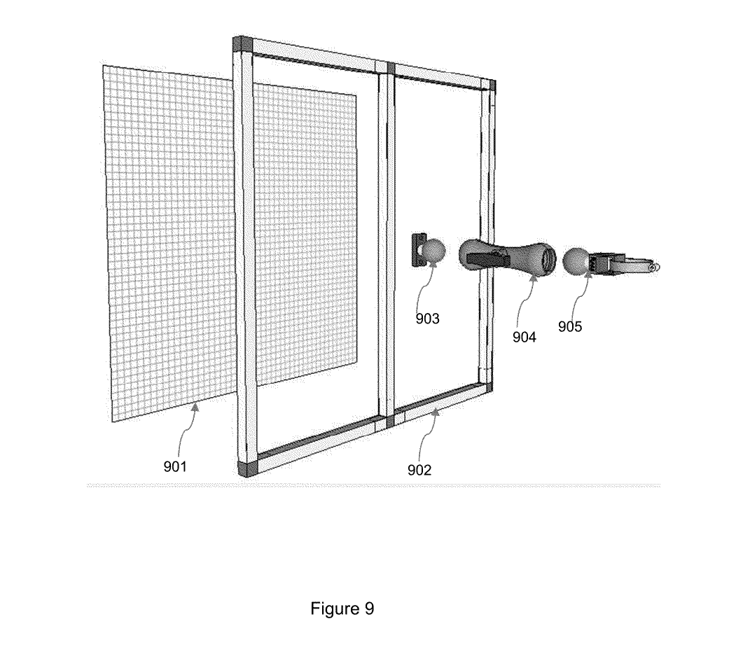

Selecting a 3-dimensional deployment: Assumption A2 assumes that the deployment is 2-dimensional. In some cases, a 3-dimensional deployment is required such as in a hilly terrain. The same method, Method I, which is used to configure a reflector to comply with constraints a1 and b1, is applicable using the articulated arm (702) in FIG. 7 and (802) in FIG. 8. A detailed description of the articulated arm is shown in FIG. 9, which shows that the articulated arm consists generally of 3 components: a first rubber ball (903) attached to a second rubber ball (905) through a lateral holder (904), which can be tightened on both rubber balls.

Selecting point to multi-point communication or multipoint to multipoint communications:

Even though the disclosure has relied on point to point communications (such as in FIGS. 1 to 6), to explain the wave bender, the same methods can be easily extended to include multipoint communications. The reason this is true is because the theory is the same in both cases. The only difference between the two cases is instead of having a known position for the fixed transmitter or for the fixed receiver, we now have a known area of coverage for mobile transceivers. For example, Method I, which is used to configure a reflector to comply with constraints a1 and b1 in point to point communications is now replaced by Method III, which is used to configure a reflector to comply with constraints a1 and b1 in point to multipoint or multipoint to multipoint communications:

Method III:

a) Select the number N and location of the reflectors using Method II.
b) In a point to multipoint system: Point the ±3 dB beam of the transmitting antenna A_{T} towards the center of the first reflector, where the first reflector is placed in the far field of the transmitting antenna.
c) Place the flat mirror at the center of the reflector.
d) Position a viewer to have his/her back perpendicular to the corresponding incident wave.
e) Ask the viewer to look at the image formed by the mirror.
f) Adjust the reflector either in a 2-dimensional fashion or in a 3-dimensional fashion until the formed image that is viewed by the viewer is that of the next reflector.
g) Repeat all above steps for every reflector, until you reach the last reflector. In this case, the following steps must be followed:
h) Place the flat mirror at the center of the last reflector.
i) Position a viewer to have his/her back perpendicular to the corresponding incident wave.
j) Ask the viewer to look at the image formed by the mirror.
k) Adjust the reflector either in a 2-dimensional fashion or in a 3-dimensional fashion until the formed image that is viewed by the viewer is that of the center of the intended coverage area.
l) In a multipoint to point system: Point the ±3 dB beam of the receiving antenna A_{R} towards the center of the last reflector.

A mixture of active and passive repeaters: So far, this disclosure has introduced the concept of adding one wave bender between a transmitting antenna A_{T} and a receiving antenna A_{R} (or between a number of transmitting antennas and a number of receiving antennas). In some situations, obstacles obstruct partial segments in the selected indirect paths. One way to resolve such a situation is by circumventing the obstructed paths using additional wave benders as long as the link budget permits it. Otherwise, an active repeater is the only way to make a connection between the two antennas. A wise decision is to always minimize the number of active repeaters because of the shortcomings associated with active repeaters as long as the link budget permits it, i.e. as long as

PL₁+PL₂+ . . . +PL_{N}≦L_{B} (9)

where PL₁ is the path loss between the transmitting antenna and the first reflector; PL_{N} is the path loss between the N^{th} reflector and the receiving antenna; PL₁ is the path loss between the (i−1)^{th} reflector and the i^{th} reflector; and L_{B} is the link budget.

Using a laser beam to configure the reflectors

Methods I and III can use a laser beam instead of light to configure the reflectors. For example, Method I is replaced by Method IV as follows:

Method IV:

a) Select the number N and location of the reflectors using Method II.
b) Place the flat mirror at the center of a reflector.
c) Position a first person to have his/her back perpendicular to the corresponding incident wave.
d) Ask the first person to point a laser beam at the mirror.
e) Ask a second person to have his/her back perpendicular to the corresponding intended outgoing direction towards the next reflector.
f) Adjust the reflector either in a 2-dimensional fashion or in a 3-dimensional fashion until the second person can see the laser beam.
g) Repeat all above steps for every reflector, until you reach the last reflector. In this case, the following steps must be followed:
h) Place the flat mirror at the center of the last reflector.
i) Position a first person to have his/her back perpendicular to the corresponding incident wave.
j) Ask the first person to point a laser beam at the mirror.
k) Ask a second person to have his/her back perpendicular to the corresponding intended outgoing direction towards the receiving antenna A_{R}.
l) Adjust the reflector either in a 2-dimensional fashion or in a 3-dimensional fashion until the second person can see the laser beam.

Using Radio Signal Strength to Configure the Reflectors:

Methods I and III can use a Received Signal Strength Indicator (RSSI), or alternatively the Signal to Interference+Noise Ratio (SINR), instead of either light (Method II) or a laser beam (Method IV) to configure the reflectors. For example, Methods I and IV are replaced by Method V as follows:

Method V:

a) Select the number N and location of the reflectors using Method II.
b) Point the ±3 dB beam of the transmitting antenna A_{T} towards the center of the first reflector, where the first reflector is placed in the far field of the transmitting antenna.
c) Point the ±3 dB beam of the second reflector towards the center of the first reflector, where the second reflector is placed in the far field of the first reflector.
d) Place an antenna at the center of the second reflector along its axis. We will refer to such an antenna as the “reflector antenna.”
e) Read the RSSI, or alternatively the Signal to Interference+Noise Ratio (SINR), that is measured at the reflector antenna indicating the link strength between itself and the transmitting antenna, A_{T}.
f) Rotate the first reflector until the RSSI, or alternatively the Signal to Interference+Noise Ratio (SINR), that is measured by the reflector antenna is maximized.
g) Repeat all above steps for every reflector, until you reach the receiving antenna, A_{K}. In this case, the following steps must be followed:
h) Read the RSSI, or alternatively the Signal to Interference+Noise Ratio (SINR), that is measured at the receiving antenna, A_{R} indicating the link strength between itself and the transmitting antenna, A_{T}.
i) Rotate the last reflector until the RSSI, or alternatively the Signal to Interference+Noise Ratio (SINR), that is measured by the receiving antenna, A_{R}, is maximized.

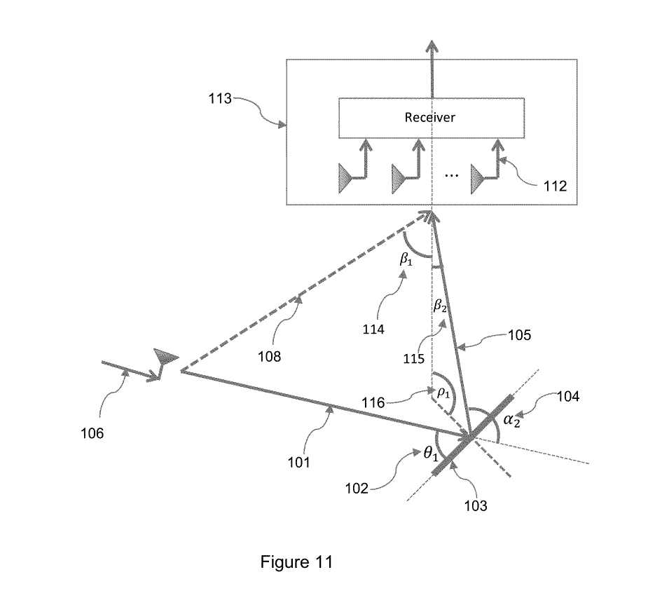

Using a wave bender to locate a transmitting antenna with AOA: FIG. 11 is a 2-dimensional schematic view of a generic embodiment of a system intended to locate a transmitting antenna (106) using one reflector (103) of known location and one active node (113) also of known location. In FIG. 11, it is assumed that the active node (113) comprises an antenna array (112) and a receiver, which together are able to estimate angles β₁ (114) and β₂ (115), corresponding to direct path (108) and indirect path (105) respectively. Since reflector (103) is of known location and of known axis, then, the angle β₁ (116) that is due to the intersection between the axis of the reflector and the axis of the antenna array is known. Therefore, the angle θ₁ (102) of the incident wave (101) can also be estimated as

θ₁=π₁+β₂−π/2 (10)

once β₂ is estimated by the receiving node (113). The intersection between the direct path (108) (which is estimated once β₁ (114) is estimated) and the incident wave (101) (which is estimated once θ₁ (102) is estimated) provides a 2-dimensional estimate of the location of the transmitting antenna (106).

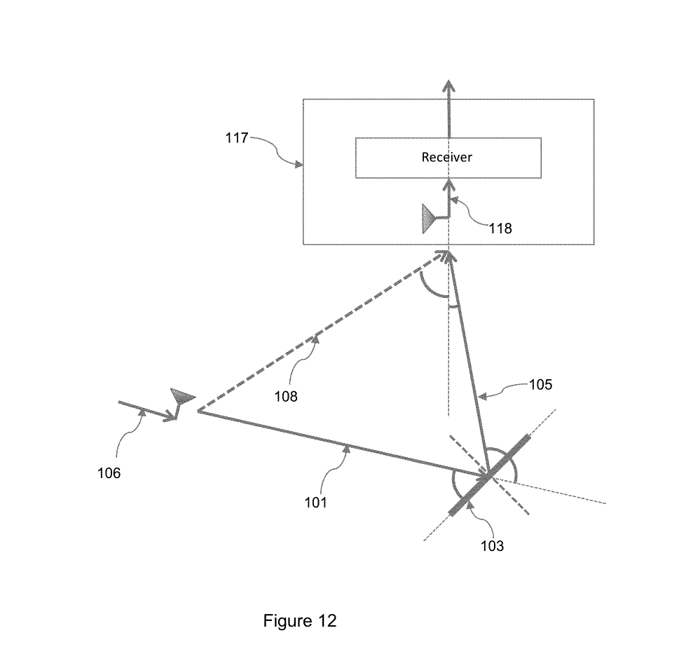

Using a wave bender to locate a transmitting antenna with TOA or TDO: FIG. 12 is a 2-dimensional schematic view of a generic embodiment of a system intended to locate a transmitting antenna (106) using one reflector (103) of known location and one active node (117) also of known location. In FIG. 12, it is assumed that the active node (117) comprises one antenna (118) and a receiver, which together are able to estimate the Time of Arrival of any wireless signal transmitted by the transmitting antenna. Given that the transmitted wireless signal in FIG. 12 is able to travel via either the direct path (108) or the indirect path (101, 105), it may be assumed that the active node (117) is able to estimate the two received signals with respect to their respective Times of Arrival: τ₁ and τ₂ which correspond to the direct path (108) and the indirect path (101, 105) respectively. Since reflector (103) is of known location, then, the distance d₁ between its axis and antenna (118) of the active node (117) is also known. Therefore, a circle of radius c(τ₁−τ₀) can be drawn centered at antenna (118) which represents all possible locations of the transmitting antenna (106), where c is the velocity of the wireless signal and τ₀ is the Time of Transmission of the transmitted wireless signal. Moreover, a second circle of radius cτ₂−d₁ can be drawn centered at reflector (103) which also represents all possible locations of the transmitting antenna (106). When the accuracy of the estimated Time of Arrivals is acceptable, the two circles intersect at two points, i.e. an ambiguity exists which must be resolved. One way to resolve such an ambiguity is to include an extra circle either from another active node or from another reflector.

In the above analysis, it was assumed that the time of transmission τ₀ is known. This is often an unrealistic assumption given the fact that clocks drift in time and cannot be synchronized to an acceptable degree. For this reason, Time Difference of Arrival is an alternative technology to Time of Arrival, which does not assume perfect knowledge of τ₀. In this case, one can assume that two reflectors are used together with an active node, and that the active node is able to estimate three Times of Arrival: τ₁, τ₂ and τ₃, τ₁ corresponds to the direct path between the transmitting antenna and the active node while τ₂ and τ₃ correspond to the two indirect paths. Once again, since each reflector is of known location, then, the distance d₁ and d₂ between each reflector and the antenna of the active node is also known. Therefore, two hyperbolas that are based on the two values: c(τ₁−τ₂) and c(τ₂−τ₃) can be drawn centered at the antenna of the active node and centered at the first reflector respectively, each hyperbola representing all possible locations of the transmitting antenna. The intersection of the two hyperbolas correspond to the possible location of the transmitting antenna. Occasionally, the two hyperbolas intersect in two points, however, this happens when the geometry of the system is poor, i.e. when the dilution of precision is large. When the system is deployed properly, i.e. with small dilution of precision, the two hyperbolas intersect at one point.

So far, we have discussed estimating the 2-dimensional location of a transmitting antenna. When the 3-dimensional location of the transmitting antenna is required, one extra reflector or one extra active node is required.

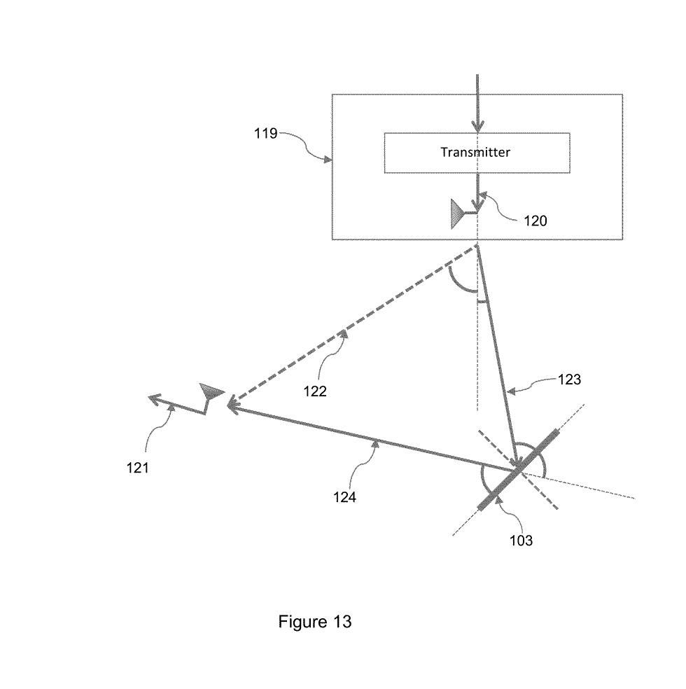

Using a wave bender to locate a receiving antenna with TOA or TDOA: FIG. 13 is a 2-dimensional schematic view of a generic embodiment of a system intended to locate a receiving antenna (121) using one reflector (103) of known location and one active node (119) also of known location. In FIG. 13, it is assumed that the active node (119) comprises one antenna (120) and a transmitter. In FIG. 13, it is also assumed that the receiving antenna is able to, estimate the Time of Arrival of any wireless signal transmitted by the active node. Given that the transmitted wireless signal in FIG. 13 is able to travel via either the direct path (122) or the indirect path (123, 124), it may be assumed that the receiving antenna (121) is able to estimate the two received signals with respect to their respective Times of Arrival: τ₁ and τ₂ which correspond to the direct path (122) and the indirect path (123, 124) respectively. Since reflector (103) is of known location, then, the distance d₁ between its axis and antenna (120) of the active node (119) is also known. Therefore, a circle of radius c(τ₁−τ₀) can be drawn centered at antenna (120) which represents all possible locations of the receiving antenna (121), where c is the velocity of the wireless signal and τ₀ is the Time of Transmission of the transmitted wireless signal. Moreover, a second circle of radius cτ₂−d₁ can be drawn centered at reflector (103) which also represents all possible locations of the receiving antenna (121). When the accuracy of the estimated Time of Arrivals is acceptable, the two circles intersect at two points, i.e. an ambiguity exists which must be resolved. One way to resolve such an ambiguity is to include an extra circle either from another active node or from another reflector.

In the above analysis, it was assumed that the time of transmission τ₀ is known. This is often an unrealistic assumption given the fact that clocks drift in time and cannot be synchronized to an acceptable degree. For this reason, Time Difference of Arrival is an alternative technology to Time of Arrival, which does not assume perfect knowledge of τ₀. In this case, one can assume that two reflectors are used together with an active node, and that the active node is able to estimate three Times of Arrival: τ₁, τ₂ and τ₃ where τ₁ corresponds to the direct path between the transmitting antenna and the active node while τ₂ and τ₃ correspond to the two indirect paths. Once again, since each reflector is of known location, then, the distance d₁ and d₂ between each reflector and the antenna of the active node is also known. Therefore, two hyperbolas that are based on the two values: c(τ₁−τ₂) and c(τ₂−₃) can be drawn centered at the antenna of the active node and centered at the first reflector respectively, each hyperbola representing all possible locations of the receiving antenna. The intersection of the two hyperbolas correspond to the possible location of the receiving antenna. Occasionally, the two hyperbolas intersect in two points, however, this happens when the geometry of the system is poor, i.e. when the dilution of precision is large. When the system is deployed properly, i.e. with small dilution of precision, the two hyperbolas intersect at one point.

So far, we have discussed estimating the 2-dimensional location of a transmitting antenna. When the 3-dimensional location of the transmitting antenna is required, one extra reflector or one extra active node is required.

It will be apparent from the foregoing disclosure that various embodiments of what is disclosed may provide these advantages:

Reducing the effect of shadowing in a wireless channel by creating new indirect paths between the transmitting antenna, A_{T}, and the receiving antenna, A_{R}, without increasing either power consumption, or latency between the two antennas, and without compromising their bit rate.

Creating new indirect paths using low cost, easy to deploy devices that are able to withstand severe weather conditions.

Replacing active repeaters by passive ones, which are easy to deploy and to maintain, have low cost and do not affect either the bit rate, the collision rate nor the latency between transmitting antenna, A_{T}, and receiving antenna, A_{R}.

Increasing the number of multipath components in a wireless Multiple Input Multiple Output (MIMO) channel by creating new indirect paths between the transmitting antenna, A_{T}, and the receiving antenna, A_{R}, without increasing either power consumption, or latency between the two antennas, and without compromising their bit rate.

Using a reflector repeater when locating either a transmitting antenna, A_{T} or a receiving antenna A_{R}. Several technologies exist for locating an active antenna such as Angle of Arrival (AOA), Time of Arrival (TOA) and Time Difference of Arrival (TDOA), among others. The minimum number of nodes of known locations that are required to estimate the 2-dimensional location of an active antenna using either AOA or TOA is two, while it is three when using TDOA.

Replacing active nodes of known location with reflector repeaters of known location when estimating the location of an active antenna. This is especially advantageous when replacing expensive active nodes such as GPS satellites or cellular Base Stations with inexpensive reflectors.

1. A passive reflector system for redirecting a telecommunications signal, the passive reflector system comprising a plurality of passive reflectors, a first passive reflector being configured to receive an initial incident signal representing a message, and to reflect the initial incident signal as an initial reflected signal representing the message, the plurality of passive reflectors being arranged in sequence, each successive passive reflector configured to receive a respective incident signal representing the message, and to reflect the respective incident signal to produce a respective reflected signal representing the message, the passive reflectors being arranged so that the respective incident signal of each successive reflector is the respective reflected signal of the reflector preceding the successive reflector, each reflector being shaped so that when the initial incident signal comprises substantially planar waves, the respective reflected signals comprise substantially planar waves.

2. The passive reflector system of claim 1 in which each reflector is contained within the 3 dB beamwidth of the respective incident signal, and the last antenna is contained within the 3 dB beamwidth of a receiving antenna receiving the reflected signal from the last reflector, and all previous reflectors are contained within an effective 3 dB beamwidth of the receiving antenna coupled with all subsequent reflectors, and in which each reflector has an effective reflected area relative to the respective reflected signal and an effective incident area relative to the respective incident signal greater than the square of an intended wavelength of operation of the system.

3. The passive reflector system of claim 1 in which each reflector has an essentially flat surface facing the respective incoming and reflected signals.

4. The passive reflector system of claim 1 in which each reflector has a concave surface facing the respective incoming and reflected signals, and each reflector is shaped so that when the initial incident signal comprises substantially planar waves, the respective reflected signals comprise converging waves, which for the reflectors other than the last reflector converge on the next reflector.

5. The passive reflector system of claim 1 in which the reflectors comprise reflectors made from conducting material in the form of a grid.

6. The passive reflector system of claim 5 in which the reflectors comprise reflectors that are rectangular in shape.

7. The passive reflector system of claim 5 in which the reflectors comprise reflectors that are elliptical in shape.

8. A method of configuring the passive reflector system of claim 1, comprising the steps of:
positioning a first mirror at the first reflector, the first mirror being aligned with the first reflector;
sighting along a line intersecting a first location and the first reflector of the plural reflectors;
adjusting the first reflector until the sighting along the line intersecting the first location and the first reflector results in sighting the next reflector in the first mirror;
for each successive reflector of the plural reflectors other than the last reflector, positioning a respective mirror at the successive reflector, the respective mirror being aligned with the successive reflector, sighting along a line intersecting the successive reflector and the reflector preceding the successive reflector, and adjusting the successive reflector until the sighting along the line intersecting the successive reflector and the reflector preceding the successive reflector results in sighting the reflector following the successive reflector in the respective mirror;
positioning a final mirror at the last reflector, the final mirror being aligned with the last reflector;
sighting along a line intersecting the reflector preceding the last reflector and the last reflector; and
adjusting the last reflector until the sighting along the line intersecting the reflector preceding the last reflector and the last reflector results in sighting the second location in the final mirror.

9. The method of claim 8 in which sighting along a line comprises viewing along the line and sighting an object or location in a mirror comprises viewing an image of the object or location in the mirror.

10. The method of claim 8 in which sighting along a line comprises directing a laser beam along the line and sighting an object or location in a mirror comprises directing a reflection of the laser beam from the mirror to the object or location.

11. The method of claim 8 in which sighting along a line comprises directing a radio signal along the line and sighting an object or location in a receiver comprises directing a reflection of the radio signal from the reflector to the object or location.

12. The method of claim 11 in which directing a reflection of the radio signal from the reflector to the object or location comprises increasing the quality of the reflected radio signal from the reflector to the object or location either in terms of the Received Signal Strength Indicator of the radio signal or in terms of Signal to Interference+Noise Ratio of the radio signal.

13. The method of claim 8 proceeding from the last antenna to the first antenna.

14. The method of claim 8 in which the first location is the location of a transmitting antenna.

15. The method of claim 8 in which the second location is the location of a receiving antenna.

16. The method of claim 8 in which the second location corresponds to an intended coverage area.

17. A method of determining a number of reflectors needed for the passive reflector system of claim 1, comprising the steps of:
selecting an initial number N of reflectors;
selecting a respective position for each of a first N−1 of the N reflectors, each with a respective angle for the respective incident signal such that the effective area of each of the first N−1 of the N reflectors as seen at the respective angle is greater than or equal to a threshold;
determining a necessary angle for the respective incident signal at the last reflector of the N reflectors based on a desired angle bending and the respective angles for the first N−1 reflectors;
determining whether the necessary angle for the last reflector gives the last reflector an effective area as seen at the necessary angle greater than or equal to the threshold; and
on determining that the necessary angle does not give the last reflector an effective area greater than or equal to the threshold, incrementing the number N by one, repeating the above steps until the necessary angle gives the last reflector an effective area greater than or equal to the threshold.

18. The method of claim 14 in which the threshold is larger than or equal to sixteen times an intended wavelength of operation of the system.

19. A method of locating a transmitting antenna in a system having at least one active receiver of known location and a number of reflectors also of known locations; the method comprising the active receiver estimating the location of the transmitter by estimating the AOAs or TOAs of the signal transmitted directly by the transmitting antenna to the active receiver and indirectly via the reflectors.

20-36. (canceled)
